(19) United States
(12) Patent Application Publication
(10) Pub. No.: US 2015/0370335 A1
(43) Pub. Date: Dec. 24, 2015

(54) DISPLAY CONTROL APPARATUS, DISPLAY APPARATUS, DISPLAY CONTROL METHOD, AND PROGRAM

(71) Applicant: SONY CORPORATION, Minato-ku, Tokyo (JP)

(72) Inventors: Tsubasa TSUKAHARA, Tokyo (JP); Takuo IKEDA, Tokyo (JP); Tetsuo IKEDA, Tokyo (JP); Atsushi IZUMIHARA, Kanagawa (JP); Kentaro KIMURA, Tokyo (JP); Yasuyuki KOGA, Kanagawa (JP)

(73) Assignee: SONY CORPORATION, Minato-ku, Tokyo (JP)

(21) Appl. No.: 14/766,467

(22) PCT Filed: Jan. 10, 2014
(86) PCT No.: PCT/JP2014/000097

§ 371 Date: Aug. 7, 2015

(30) Foreign Application Priority Data
Feb. 22, 2013 (JP) 2013-033875

(51) Int. Cl. G06F 3/01; G06F 3/041; H04N 5/232; G02B 27/01; G06F 3/14

(52) U.S. Cl. CPC G06F 3/017; G02B 27/0172; G06F 3/14; H04N 5/23229; G06F 3/041; G02B 2027/0178

(57) ABSTRACT

A display control apparatus of an illustrative embodiment controls display of a movable object on a display plane such that, in response to a movement operation, a movement trajectory of the movable object has a component that appears perpendicular to the display plane, wherein the movement operation is initiated when an operation device receives a user input having a component perpendicular to the display plane.

### CROSS REFERENCE TO RELATED APPLICATIONS

This application claims the benefit of Japanese Priority Patent Application JP 2013-033875 filed Feb. 22, 2013, the entire contents of which are incorporated herein by reference.

### TECHNICAL FIELD

The present disclosure relates to a display control apparatus, a display apparatus, a display control method, and a program.

### BACKGROUND ART

For example, head-mounted displays (hereinafter also referred to as “HMDs”) including operation devices have been developed. As a technology for an HMD including an operation device, the technology disclosed in PTL 1 described below can be exemplified.

### CITATION LIST

### Patent Literature

[PTL 1]

JP 2011-249966A

### SUMMARY

### Technical Problem

For example, in a display apparatus mounted on a user so that a display surface is located in front of the user, as in an HMD, an operation device operable by the user is installed to the side of the user on which the display apparatus is mounted in some cases. Here, when the user operates the operation device in the foregoing display apparatus, it is difficult for the user to perform an operation after visually recognizing the operation device. For this reason, in the foregoing display apparatus, there is a concern that operability of a user may deteriorate, for example, when a change (for example, movement of a display object or a change in a display object selected with a cursor or the like) in display content displayed on the display surface and produced as the result of an operation performed by the user himself or herself is not a desired change.

Here, for example, when the technology disclosed in PTL 1 is used, a guide display image guiding a function of an operation device is displayed on a display surface. Therefore, for example, when the technology disclosed in PTL 1 is used and a user can perform an operation according to the guide display image, a desired operation can be caused to be performed by the user. Accordingly, for example, when the technology disclosed in PTL 1 is used, there is a probability of deterioration in the operability of the user being prevented to some extent.

However, as described above, in a display apparatus in which an operation device is installed on a side of a user on which the display apparatus is mounted, it is difficult for the user to perform an operation after visually recognizing the operation device. For this reason, for example, even when the guide display image is displayed on the display surface, as in the technology disclosed in PTL 1, the user may not be said to intuitively comprehend content indicated by the guide display image and operation content on the operation device. Accordingly, for example, even when the technology disclosed in PTL 1 is used, for example, the operability of the user may deteriorate, as described above.

In an embodiment of the present disclosure, it is desirable to provide a novel and improved display control apparatus, a novel and improved display apparatus, a novel and improved display control method, and a novel and improved program capable of promoting an improvement in operability of a user.

### Solution to Problem

In view of the above, the embodiments of the present technology are provided. According to an illustrative embodiment, a display control apparatus is provided to control display of a movable object on a display plane such that, in response to a movement operation, a movement trajectory of the movable object has a component that appears perpendicular to the display plane, wherein the movement operation is initiated when an operation device receives a user input having a component perpendicular to the display plane.

### Advantageous Effects of Invention

According to the embodiments of the present disclosure, an improvement in operability of a user can be promoted.

### BRIEF DESCRIPTION OF DRAWING

FIG. 1 is an explanatory diagram illustrating an example of a display apparatus according to an embodiment of the present disclosure.

FIG. 2 is an explanatory diagram illustrating an example of a problem occurring at the time of use of the display apparatus in which the display surface is located in front of the user on which the display apparatus is mounted and the operation device is installed on a side of the user on which the display apparatus is mounted.

FIG. 3 is an explanatory diagram illustrating a first example of a display control process according to the present embodiment in a display control apparatus according to an embodiment of the present disclosure.

FIG. 4 is an explanatory diagram illustrating the first example of a display control process according to the present embodiment in a display control apparatus according to an embodiment of the present disclosure.

FIG. 5 is an explanatory diagram illustrating the first example of a display control process according to the present embodiment in a display control apparatus according to an embodiment of the present disclosure.

FIG. 6A is an explanatory diagram illustrating the first example of a display control process according to the present embodiment in a display control apparatus according to an embodiment of the present disclosure.

FIG. 6B is an explanatory diagram illustrating the first example of a display control process according to the present embodiment in a display control apparatus according to an embodiment of the present disclosure.

FIG. 6C is an explanatory diagram illustrating the first example of a display control process according to the present embodiment in a display control apparatus according to an embodiment of the present disclosure.

FIG. 7 is an explanatory diagram illustrating a second example of a display control process according to the present embodiment in a display control apparatus according to an embodiment of the present disclosure.

FIG. 8A is an explanatory diagram illustrating the second example of a display control process according to the present embodiment in a display control apparatus according to an embodiment of the present disclosure.

FIG. 8B is an explanatory diagram illustrating the second example of a display control process according to the present embodiment in a display control apparatus according to an embodiment of the present disclosure.

FIG. 9 is a block diagram illustrating an example of the configuration of the display control apparatus according to an embodiment of the present disclosure.

FIG. 10 is an explanatory diagram illustrating an example of a hardware configuration of the display control apparatus according to an embodiment of the present disclosure.

FIG. 11 is an explanatory diagram illustrating an example of a display system according to an embodiment of the present disclosure.

FIG. 12 is an explanatory diagram illustrating an example of an operable operation device relevant to control of display on the display surface of the display apparatus according to an embodiment of the present disclosure in the display system.

FIG. 13A is an explanatory diagram illustrating an example of an operation using the operation device in the display system an embodiment of the present disclosure.

FIG. 13B is an explanatory diagram illustrating an example of an operation using the operation device in the display system according to an embodiment of the present disclosure.

FIG. 13C is an explanatory diagram illustrating an example of an operation using the operation device in the display system according to an embodiment of the present disclosure.

FIG. 13D is an explanatory diagram illustrating an example of an operation using the operation device in the display system according to an embodiment of the present disclosure.

FIG. 13E is an explanatory diagram illustrating an example of an operation using the operation device in the display system according to an embodiment of the present disclosure.

FIG. 14 is an explanatory diagram illustrating an example of display in a display system according to an embodiment of the present disclosure.

FIG. 15A is an explanatory diagram illustrating another example of the display in the display system according to an embodiment of the present disclosure.

FIG. 15B is an explanatory diagram illustrating another example of the display in the display system according to an embodiment of the present disclosure.

FIG. 15C is an explanatory diagram illustrating another example of the display in the display system according to an embodiment of the present disclosure.

FIG. 15D is an explanatory diagram illustrating another example of the display in the display system according to an embodiment of the present disclosure.

FIG. 15E is an explanatory diagram illustrating another example of the display in the display system according to an embodiment of the present disclosure.

FIG. 15F is an explanatory diagram illustrating another example of the display in the display system according to an embodiment of the present disclosure.

FIG. 15G is an explanatory diagram illustrating another example of the display in the display system according to an embodiment of the present disclosure.

FIG. 15H is an explanatory diagram illustrating another example of the display in the display system according to an embodiment of the present disclosure.

FIG. 16A is an explanatory diagram illustrating another example of the display in the display system according to an embodiment of the present disclosure.

FIG. 16B is an explanatory diagram illustrating another example of the display in the display system according to an embodiment of the present disclosure.

FIG. 17A is an explanatory diagram illustrating another example of the display in the display system according to an embodiment of the present disclosure.

FIG. 17B is an explanatory diagram illustrating another example of the display in the display system according to an embodiment of the present disclosure.

FIG. 17C is an explanatory diagram illustrating another example of the display in the display system according to an embodiment of the present disclosure.

FIG. 17D is an explanatory diagram illustrating another example of the display in the display system according to an embodiment of the present disclosure.

FIG. 17E is an explanatory diagram illustrating another example of the display in the display system according to an embodiment of the present disclosure.

FIG. 17F is an explanatory diagram illustrating another example of the display in the display system according to an embodiment of the present disclosure.

### DESCRIPTION OF EMBODIMENTS

Hereinafter, preferred embodiments of the present disclosure will be described in detail with reference to the appended drawings. Through this specification and the drawings, the same reference numerals are given to constituent elements having substantially the same functional configurations and the repeated description will be omitted.

Hereinafter, the description will be made in the following order.

1. Display control method according to embodiment

2. Display control apparatus according to embodiment

3. Program according to embodiment

4. Display system according to embodiment

### Display Control Method According to Embodiment

Before the configuration of a display control apparatus according to an embodiment is described, a display control method according to the present embodiment will first be described. Hereinafter, the display control method according to the present embodiment will be described exemplifying a case in which the display control apparatus according to the present embodiment performs a process relevant to the display control method according to the present embodiment.

### [1] Example of Display Apparatus According to Embodiment

First, an example of the configuration of a display apparatus according to the present embodiment controlled by the process relevant to the display control method according to the present embodiment and the display control apparatus according to the present embodiment will be described. The display control apparatus according to the present embodiment and the display apparatus according to the present embodiment may be, for example, separate apparatuses or may be an integrated apparatus. When the display control apparatus according to the present embodiment and the display apparatus according to the present embodiment are an integrated apparatus, the display control apparatus according to the present embodiment is configured to control the self-apparatus (the display control apparatus according to the present embodiment).

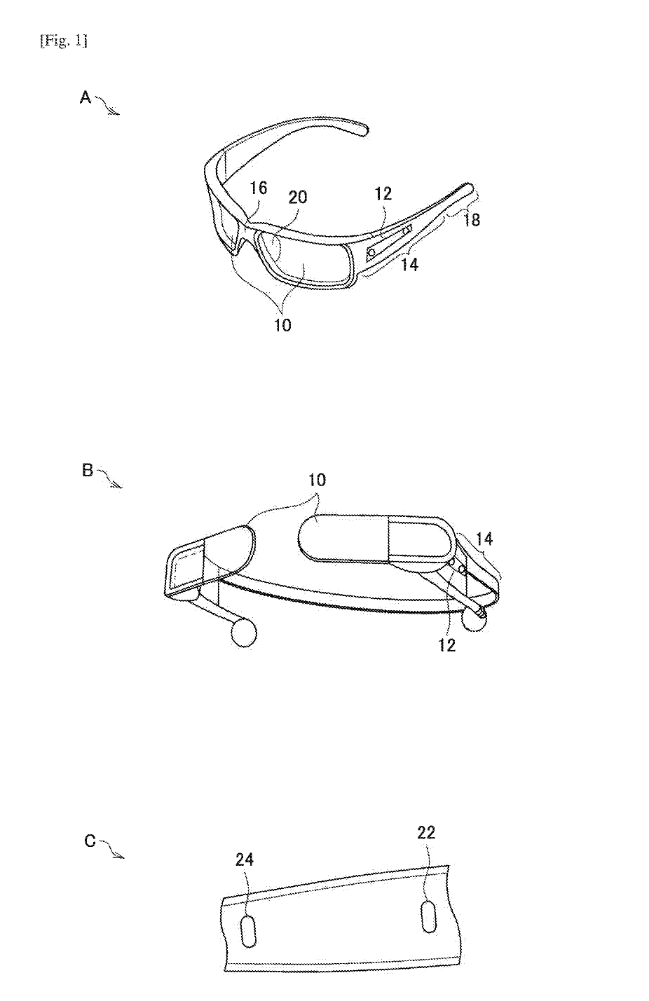

FIG. 1 is an explanatory diagram illustrating an example of the display apparatus according to the present embodiment. For example, the display apparatus according to the present embodiment is mounted on a user so that a display surface is located in front of the user. Here, A shown in FIG. 1 indicates an example of an HMD and B shown in FIG indicates another example of an HMD. Further, C shown in FIG. 1 indicates an example of an operation device included in the HMD.

The display apparatus according to the present embodiment includes, for example, a display unit 10 and an operation unit 12. As indicated by A of FIG. 1 and B of FIG. 1, for example, the display apparatus according to the present embodiment includes various members such as one or two or more temple members 14, one or two or more bridge members 16, one or two or more modern members 18, and one or two or more pad members 20.

For example, the display unit 10 includes display surfaces that can display a display object and is disposed at a position in front of two eyes of the user so that the display surfaces are located in front of the user at the time of the mounting on the user. Here, in FIG. 1, the display unit 10 is configured to include the display surfaces corresponding to the two eyes of the user, but the configuration of the display unit according to the present embodiment is not limited to the foregoing configuration. For example, the display unit according to the present embodiment may be configured to include a display surface corresponding to only one eye of the user.

Here, examples of the display objects according to the present embodiment include icons corresponding to applications or the like, thumbnail images of still images or moving images, content images indicating still images or moving images, and images (still images or moving images) used to notify the user. Further, examples of the display objects according to the present embodiment may further include images (still images or moving images) relevant to a layout of a screen.

The operation unit 12 is installed to be located at position of a side of the user at the time of the mounting on the user. As indicated by A and B of FIG. 1, the position at which the operation unit 12 is installed can be, for example, a position on the temple member 14 included in the display apparatus.

As indicated by A and B of FIG. 1, for example, the operation unit 12 is installed on the left side of the user at the time of the mounting on the user. The position at which the operation unit 12 is installed is not limited to the left side of the user at the time of the mounting on the user. For example, the operation unit 12 may be installed on the right side of the user at the time of the mounting on the user or may be installed on both of the right and left sides of the user at the time of the mounting on the user. Hereinafter, the case in which the operation unit 12 is installed on the left side of the user at the time of the mounting on the user will be mainly described as an example.

For example, the operation unit 12 includes one operation device or two or more operation devices. Examples of the operation device included in the operation unit 12 include sensors and buttons. Examples of the sensors according to the present embodiment include infrared proximity sensors, touch sensors of various types such as an electrostatic capacitance type, and image sensors.

The operation unit 12 detects a user's operation using the included operation device and generates an operation signal according to a detection result.

Here, for example, “an input operation on the operation device by the user” can be exemplified as the user's operation detected by the operation device according to the present embodiment. When “the input operation on the operation device by the user” is detected as a user's operation by the operation device, the operation signal according to the present embodiment indicates, for example, an operation performed on the operation device by the user.

The user's operation detected by the operation device according to the present embodiment is not limited to the foregoing operation. For example, when the operation device according to the present embodiment is a device capable of detecting that the user approaches the operation device, such as an infrared proximity sensor or an image sensor, the user's operation detected by the operation device according to the present embodiment may he “an operation in which the user approaches the operation device.” When “the operation in which the user approaches the operation device” is detected as the user's operation by the operation device, the operation signal according to the present embodiment can indicate, for example, a previous stage (a preparation stage before an operation is performed) of an operation which the user performs on the operation device.

C of FIG. 1 indicates an example in which the operation unit 12 includes two sensors, i.e., a first sensor 22 located in front of the user at the time of the mounting on the user and a second sensor 24 located behind the user at the time of the mounting on the user.

The sensors included in the operation unit according to the present embodiment are not limited to the example indicated by C of FIG. For example, the operation unit according to the present embodiment may include a sensor in which the first sensor 22 and the second sensor 24 are integrated.

For example, when the display apparatus according to the present embodiment is mounted on the user, as indicated by A and B of FIG. 1, the display surfaces are located in front of the user and the operation device is configured to be located on a side of the user.

Of course, the outer appearance of the display apparatus according to the present embodiment is not limited to the outer appearance indicated by A and B of FIG. 1.

The configuration of the display apparatus according to the present embodiment is not limited to the configuration indicated by A and B of FIG. 1.

For example, the display apparatus according to the present embodiment may have a configuration in which an external operation device is connected to a position of a side of the user at the time of the mounting on the user. When the external operation device is connected to the position of the side of the user at the time of the mounting on the user, the display apparatus according to the present embodiment may he configured not to include the operation unit 12. That is, “the operation device installed at the position of the side of the user in the display apparatus according to the present embodiment” refers to an operation device configured as the operation unit included in the display apparatus according to the present embodiment and/or an external operation device connected to a position of a side of the user on which the display apparatus according to the present embodiment is mounted in the display apparatus according to the present embodiment. Further, an example of the user's operation on “the operation device installed at the position of the side of the user in the display apparatus according to the present embodiment” will be described below in “[1] Example of operation in display system 1000.”

The display apparatus according to the present embodiment includes a micro processing unit (MPU) and various processing circuits and may include a control unit (not illustrated) that controls the entire display apparatus. When the display apparatus according to the present embodiment and the display control apparatus according to the present embodiment are an integrated apparatus, for example, the control unit (not illustrated) serves to perform a process relevant to the display control method according to the present embodiment to be described below.

The display apparatus according to the present embodiment may include a communication unit (not illustrated) that performs wireless/wired communication with an external apparatus such as the display control apparatus according to the present embodiment. Examples of the communication unit (not illustrated) include a communication antenna and a radio frequency (RF) circuit (wireless communication), an IEEE 802.15.1 port and a transmission and reception circuit (wireless communication), an IEEE 802.11b port and a transmission and reception circuit (wireless communication), and a local area network (LAN) terminal and a transmission and reception circuit (wired communication). For example, the display apparatus according to the present embodiment may be configured to perform communication with an external apparatus such as the display control apparatus according to the present embodiment via a connected external communication device.

For example, the display apparatus according to the present embodiment may include a battery (not illustrated) that supplies power to each device. Here, a secondary battery such as a lithium-ion battery can be exemplified as the battery (not illustrated) included in the display apparatus according to the present embodiment. When the display apparatus according to the present embodiment receives power from an external power supply such as a commercial power supply to be driven, the display apparatus according to the present embodiment may not include a battery (not illustrated).

The display apparatus according to the present embodiment is not limited to the HMD indicated by A and B of FIG. 1. For example, the display apparatus according to the present embodiment may be an eyeglass (monocle) type apparatus. When the display apparatus according to the present embodiment is mounted on the user, for example, the display apparatus can be applied to an apparatus that has any shape and a configuration in which a display surface is located in front of the user and an operation device is located on a side of the user.

Hereinafter, the process relevant to the display control method according to the present embodiment in the display control apparatus according to the present embodiment will be described exemplifying a case in which the display apparatus according to the present embodiment is the HMD indicated by A of FIG. 1.

### [2] Process Relevant to Display Control Method According to Embodiment

As described above, for example, in “a display apparatus in which a display surface is located in front of a user on which the display apparatus is mounted and an operation device is installed on a side of the user on which the display apparatus is mounted” as in the HMD indicated by A of FIG. 1, it is difficult for the user to perform an operation after visually recognizing the operation device. For this reason, in the foregoing display apparatus, for example, there is a concern that operability of the user may deteriorate. For example, a change in display content of the display surface occurring as a result of an operation performed by the user is not a desired change.

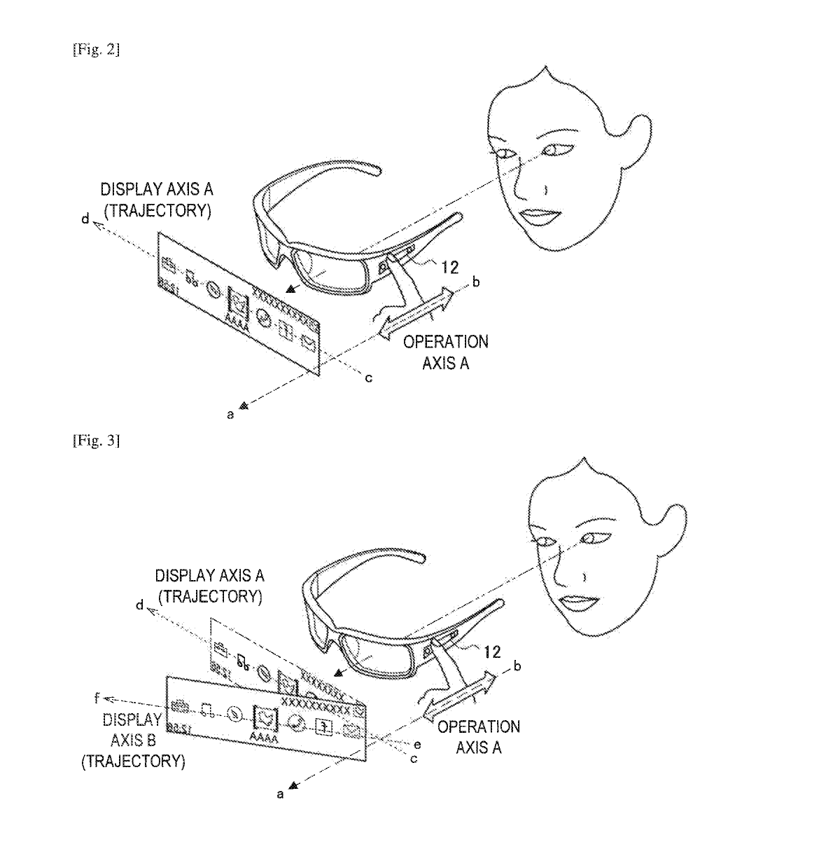

FIG. 2 is an explanatory diagram illustrating an example of a problem occurring at the time of use of the display apparatus in which the display surface is located in front of the user on which the display apparatus is mounted and the operation device is installed in a side of the user on which the display apparatus is mounted.

Here, FIG. 2 illustrates an example in which display objects displayed on the display surface are moved on a display axis A (corresponding to a trajectory to be described below) when the user operates the operation unit 12 of the display apparatus. That is, in the example illustrated in FIG. 2, the display objects are moved to be parallel to the display surface by moving the display objects on the display axis A. A change in the display content on the display surface by the user's operation is not limited to the foregoing change. For example, FIG. 2 may illustrate an example in which a cursor (or a focus frame and the same applies below) used to select a display object displayed on the display surface is moved on the display axis A (corresponding to a trajectory to be described below) when the user operates the operation unit 12 of the display apparatus. Further, FIG. 2 illustrates an example in which a user's operation on the operation unit 12 is an operation corresponding to an operation axis A.

Here, the operation axis according to the present embodiment refers to a virtual axis corresponding to a direction in which a medium (for example, a hand or a finger of a user) for an operation is assumed to be moved when the user on which a display apparatus (which is a display apparatus in which a display surface is located in front of a user on which the display apparatus is mounted and an operation device is installed in a side of the user on which the display apparatus is mounted) is mounted operates the operation device installed at a position of the side of the user.

When the operation device according to the present embodiment includes a plurality of sensors, as indicated by C of FIG. 1, a direction (for example, a direction corresponding to a straight line passing through the central position of each sensor) in which the medium used in the operation by the user is moved between the plurality of sensors can be exemplified as the operation axis according to the present embodiment. When the operation device according to the present embodiment is a touch sensor of various types such as an electrostatic capacity type, a direction in which the operation device according to the present embodiment can detect a slide operation of the user can be exemplified as the operation axis according to the present embodiment. When the operation device according to the present embodiment is, for example, a button (or a button group including a plurality of buttons), such as an arrow key, with which an input can be performed at least in the horizontal direction, the horizontal axis in the button can be exemplified as the operation axis according to the present embodiment. Of course, examples of the operation axis according to the present embodiment are not limited to the foregoing

For example, as illustrated in FIG. 2, when the operation axis A and the display axis A are perpendicular to each other (or intersect at an angle close to a right angle; the same applies below), the user may not easily cause a direction in which an operation is performed on the operation unit 12 to correspond to a direction in which the display objects displayed on the display surface is moved. For example, when the user performs an operation in direction A illustrated in FIG. 2, it is difficult to determine whether the display objects are moved in direction c illustrated in FIG. 2 or the display objects are moved in direction d illustrated in FIG. 2.

Accordingly, for example, as illustrated in FIG. 2, when the operation axis A and the display axis A are perpendicular to each other, there is a concern that operability of the user may deteriorate, for example, since the display objects are not moved in a user's intended direction.

As described above, for example, even when the guide display image is displayed on the display surface as in the technology disclosed in PTL 1, an improvement in the operability of the user may not be promoted, for example, when the technology disclosed in PTL, 1 is used, due to the occurrence of the deterioration in the operability of the user.

Accordingly, for example, the control display apparatus according to the present embodiment controls display of display objects displayed on the display surface in the display apparatus (a display apparatus which is mounted on a user such that a display surface on which display objects are displayable is located in front of the user and in which an operation device is installed at a position of a side of the user on which the display apparatus is mounted) according to the present embodiment, as indicated by A and B of FIG. 1 (display control process). The display control apparatus according to the present embodiment controls the display of the display objects such that at least the part of the trajectory along which the display objects are moved indicates the trajectory having the vertical direction component with respect to the display surface, based on the operation signal acquired in response to the detection in the operation device installed at the position of the side of the user on which the display apparatus according to the present embodiment is mounted.

More specifically, based on an acquisition state of an operation signal, the display control apparatus according to the present embodiment selectively controls the display of the display objects such that at least the part of the trajectory along which the display objects are moved indicates the trajectory having the vertical direction component with respect to the display surface. An example of a process relevant to the selective display of the display objects in the display control apparatus according to the present embodiment will be described later.

Here, one or two or more operation devices included in the operation unit 12, as illustrated in FIG. 1, can be exemplified as the operation device according to the present embodiment installed at the position of the side of the user on which the display apparatus is mounted. The operation device according to the present embodiment installed at the position of the side of the user on which the display apparatus is mounted is not limited to one or two or more operation devices included in the operation unit 12. For example, the operation device according to the present embodiment installed at the position of the side of the user on which the display apparatus is mounted may be one or two or more external operation devices connected to positions of a side of the user in the display apparatus according to the present embodiment when the display apparatus according to the present embodiment is mounted on the user.

Hereinafter, a case in which “the operation signal acquired in response to the detection in the operation device installed at the position of the side of the user on which the display apparatus is mounted” acquired by the display control apparatus according to the present embodiment is an operation signal acquired in response to the detection in the operation unit 12 illustrated in FIG. 1 will be exemplified. Here, for example, when the display control apparatus according to the present embodiment and the display apparatus according to the present embodiment are an integrated apparatus, the display control apparatus according to the present embodiment performs a process based on an operation signal delivered from the included operation unit 12. When the display control apparatus according to the present embodiment and the display apparatus according to the present embodiment are separate apparatuses, the display control apparatus according to the present embodiment performs a process based on the operation signal, which is received by an included communication unit (to be described below) or a connected external communication device, in response to the detection in the operation unit 12 of the display apparatus according to the present embodiment.

The trajectory according to the present embodiment is, for example, a path along which display objects are moved or a path along which a position at which display objects are selected is moved, as in the display axis A illustrated in FIG. 2. A virtual path which is not perceived by the user on the display surface can be exemplified as the trajectory according to the present embodiment. The trajectory according to the present embodiment is not limited to the virtual path which is not perceived by the user. For example, the trajectory according to the present embodiment may be perceived visually by the user when the trajectory is displayed on the display surface. Hereinafter, the trajectory according to the present embodiment indicates a “display axis” in some cases.

As described above, the trajectory according to the present embodiment corresponds to, for example, a “display axis” such as the display axis A illustrated in FIG. 2. Here, when at least a part of the trajectory according to the present embodiment indicates a trajectory having a vertical direction component with respect to the display surface, as in the example of FIG. 2, the trajectory according to the present embodiment having the vertical direction component has a parallel direction component with respect to the operation axis A.

Accordingly; “controlling the display of display objects such that at least a part of the trajectory along which the display objects are moved indicates the trajectory having the vertical direction component with respect to the display surface” in the display control process according to the present embodiment corresponds to, for example, “controlling display of the display objects such that at least a part of the trajectory along which the display objects are moved indicates a trajectory having a parallel direction component with respect to the operation axis according to the present embodiment.”

For example, when an operation signal acquired in response to the detection in the operation unit 12 is acquired, the display control apparatus according to the present embodiment moves the display objects by performing scrolling in a direction corresponding to the operation direction indicated by the operation signal along the trajectory according to the present embodiment.

A method of moving the display objects according to the present embodiment is not limited to the foregoing method. For example, the display control apparatus according to the present embodiment may move the display, objects by discretely changing positions at which the display objects are displayed in a direction corresponding to an operation direction indicated by the operation signal on the trajectory according to the present embodiment.

When the display control apparatus according to the present embodiment and the display apparatus according to the present embodiment are separate apparatuses, the display control apparatus according to the present embodiment controls the display of the display objects in the display apparatus according to the present embodiment, for example, by causing the included communication unit (to be described below) or a connected external communication device to transmit a display control signal used to control the display on the display surface of the display unit 10 to the display apparatus according to the present embodiment. When the display control apparatus according to the present embodiment and the display apparatus according to the present embodiment are an integrated apparatus, the display control apparatus according to the present embodiment controls the display of the display objects in the display apparatus according to the present embodiment by delivering a display control signal to the included display unit 10.

Here, a signal relevant to the control of controlling a display timing or the like of the display object can be exemplified as the display control signal according to the present embodiment. For example, the display control signal according to the present embodiment may include a signal indicating data relevant to the display content such as data indicating the display object to be displayed on the display surface or data indicating a layout.

A control target for which the display control apparatus according to the present embodiment controls the display of the display object is not limited to the display apparatus according to the present embodiment. For example, the display control apparatus according to the present embodiment may set, as the control target, an apparatus such as a communication apparatus such as a smartphone or a computer such as a personal computer (PC) rather than the display apparatus according to the present embodiment.

Hereinafter, the display control process according to the present embodiment will be described more specifically. The display control process according to the present embodiment will be described below mainly exemplifying a case in which the operation device such as the operation unit 12 installed at the position of the side of the user in the display apparatus according to the present embodiment is installed on the left side of the user at the time of the mounting on the user.

For example, when the operation signal acquired in response to the detection in the operation unit 12 is acquired, the display control apparatus according to the present embodiment controls the display of the display objects such that at least the part of the trajectory along which the display objects are moved indicates the trajectory having the vertical direction component with respect to the display surface by “displaying at least some of the display objects displayed on the display surface so that some of the display objects have the vertical direction component with respect to the display surface.

Here, as described above, the operation signal according to the present embodiment indicates, for example, an operation performed on the operation device by the user or a previous stage (a preparation stage before an operation is performed) of an operation performed on the operation device by the user. That is, for example, when the user performs an operation on the operation device or when the user attempts to perform an operation on the operation device, the display control apparatus according to the present embodiment can “control the display of the display objects such that at least the part of the trajectory along which the display objects are moved indicates the trajectory having the vertical direction component with respect to the display surface.”

### (i) First Example of Display Control Process According to Embodiment

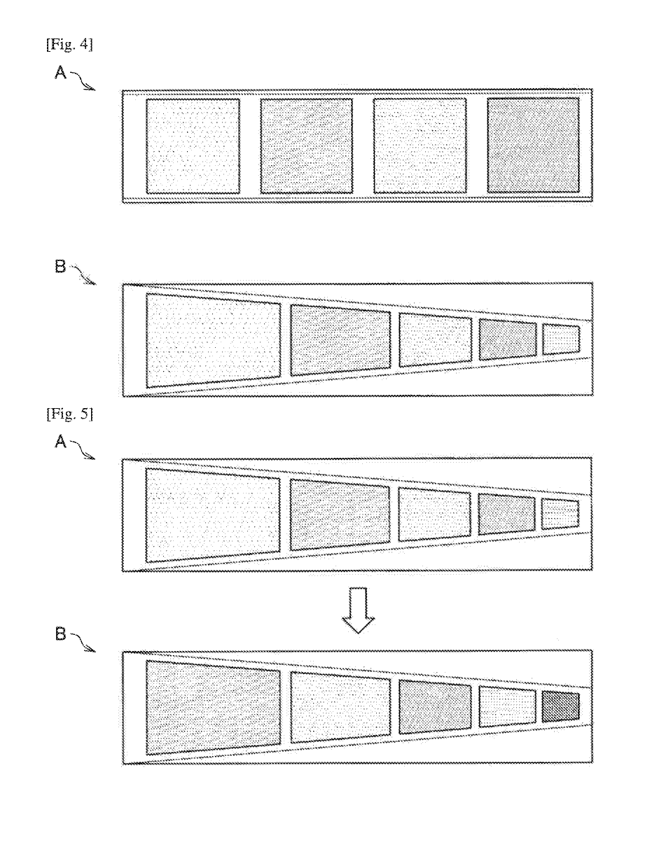

FIG. 3 is an explanatory diagram illustrating a first example of the display control process according to the present embodiment in the display control apparatus according to the present embodiment. Here, FIG. 3 illustrates the first example of the display in which at least some of the display objects have the vertical direction component with respect to the display surface. As in FIG. 2, FIG. 3 illustrates the example in which the display objects displayed on the display surface are moved on the display axis (corresponding to the trajectory according to the present embodiment) when the user operates the operation unit 12 of the display apparatus.

For example, as described with reference to FIG. 2, for example, when the operation axis A and the display axis are perpendicular to each other, as in the display axis A of FIG. 3, there is a concern that operability of the user may deteriorate. Accordingly, for example, the display control apparatus according to the present embodiment displays all of the display objects displayed on the display surface so that all of the display objects have the vertical direction component with respect to the display surface, as in the display objects displayed along the display axis B of FIG. 3.

For example, the operation axis A and the display axis B are closer to parallel in comparison to the operation axis A and the display axis A by displaying all of the display objects displayed on the display surface so that all of the display objects have the vertical direction component with respect to the display surface, as in the display objects displayed along the display axis B of FIG. 3. Accordingly, for example, the user can more intuitively recognize that the operation direction A illustrated in FIG. 3 corresponds to a movement direction f illustrated in FIG. 3 and an operation direction b illustrated in FIG. 3 corresponds to a movement direction e illustrated in FIG. 3. As described above, since the user can more intuitively recognize the operation direction and the movement direction, for example, a change in display content on the display surface occurring as the result of the operation performed by the user is prevented from not being a change desired by the user.

Accordingly, for example, when the display control apparatus according to the present embodiment displays all of the display objects displayed on the display surface so that all of the display objects have the vertical direction component with respect to the display surface, the display control apparatus according to the present embodiment can promote an improvement in the operability of the user.

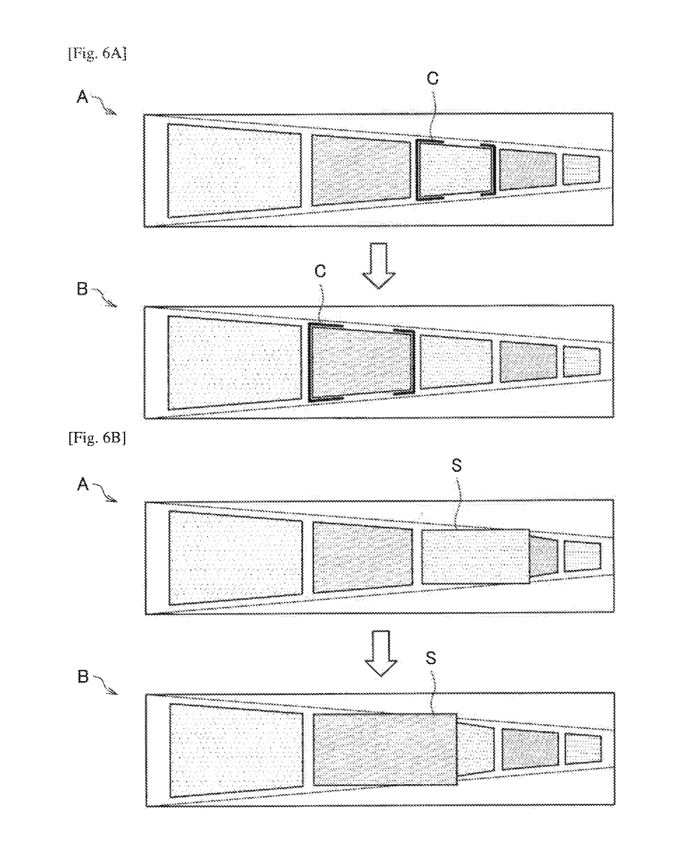

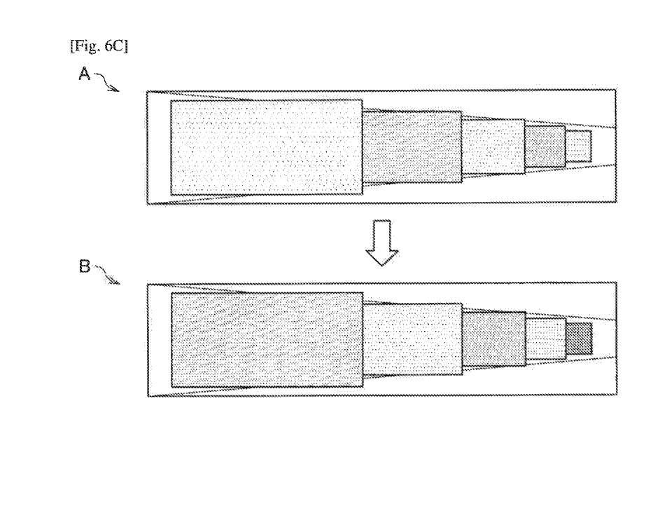

FIGS. 4 and 5 are explanatory diagrams illustrating the first example of the display control process according to the present embodiment in the display control apparatus according to the present embodiment. Here, A illustrated in FIG. 4 indicates an example of a method of showing the display objects displayed on the display surface when the display axis is the display axis A illustrated in FIG. 3. Further, B illustrated in FIG. 4 indicates an example of a method of showing the display objects displayed on the display surface when the display axis is the display axis B illustrated in FIG. 3. FIG, 5 illustrates an example of a change in display content corresponding to an operation signal according to a user's operation in the showing method indicated by B of FIG. 4.

When the display axis is the display axis A illustrated in FIG. 3, the entire display axis has no vertical direction component with respect to the display surface. The display objects displayed on the display surface are not drawn in perspective, for example, as indicated by A of FIG. 4. Accordingly; for example, when the user operates the operation unit 12 in the operation direction b illustrated in FIG. 3, it is difficult for the user to guess how the display objects indicated by A of FIG. 4 are moved.

On the other hand, when the display axis is the display axis B illustrated in FIG. 3, the entire display axis has the vertical direction component with respect to the display surface. The display objects displayed on the display surface are drawn in perspective, for example, as indicated by B of FIG. 4. Accordingly, for example, when the user operates the operation unit 12 in the operation direction b illustrated in FIG. 3, the user can more easily guess that the display objects are moved in a direction e illustrated in FIG. 3, that is, the display objects are changed from the state indicated by A of FIG. 5 to the state indicated by B of FIG. 5.

For example, when the entire display axis has the vertical direction component with respect to the display surface, as in the display axis B of FIG. 3, the change in the display content corresponding to the operation signal according to the user's operation is not limited to the example illustrated in FIG. 5.

FIGS. 6A to 6C are explanatory diagrams illustrating the first example of the display control process according to the present embodiment in the display control apparatus according to the present embodiment. Here, FIGS. 6A to 6C illustrate different examples of the change in the display content according to the user's operation in the showing method indicated by B of FIG. 4.

For example, as indicated by A and B of FIG. 6A, the display control apparatus according to the present embodiment may move a cursor C indicating a selected display object in the direction of the display axis corresponding to the operation signal according to the user's operation.

For example, the display control apparatus according to the present embodiment changes expression (S illustrated in FIG. 6B) of the selected display object and expression of the unselected display objects. Further, the display control apparatus according to the present embodiment may change the expression of the display objects in the direction of the display axis corresponding to the operation signal according to the user's operation, for example, as indicated by A and B of FIG. 6B.

The display control apparatus according to the present embodiment may move the display objects in the direction of the display axis corresponding to the operation signal according to the user's operation, as in FIG. 5, for example, when all of the display objects are expressed like S illustrated in FIG. 6B, for example, as indicated by A and B of FIG. 6C.

A change in the display content corresponding to the operation signal according to the user's operation is not limited to FIGS. 5 and 6A to 6C. For example, the display control apparatus according to the present embodiment may display each of the display objects displayed on the display surface as a 3-dimensional image formed by a right-eye image corresponding to the right eye of the user and a left-eye image corresponding to the left eye of the user and may change convergence of each display object.

### (ii) Second Example of Display Control Process According to Embodiment

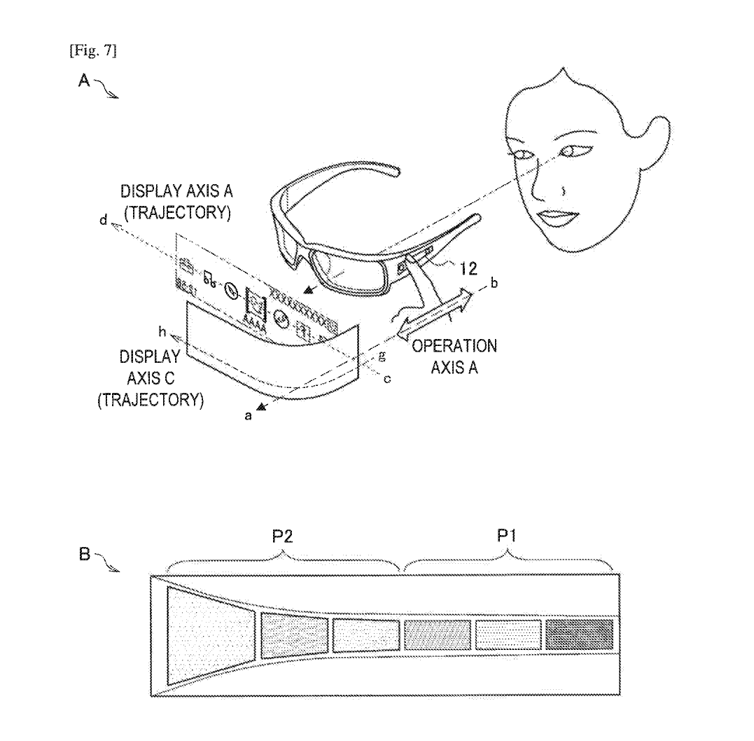

FIG. 7 is an explanatory diagram illustrating a second example of the display control process according to the present embodiment in the display control apparatus according to the present embodiment. Here, FIG. 7 illustrates the second example of the display in which at least some of the display objects have the vertical direction component with respect to the display surface. As in FIG. 2, A illustrated in FIG. 7 indicates an example in which display objects displayed on the display surface arc moved on a display axis (corresponding to the trajectory according to the present embodiment) when the user operates the operation unit 12 of the display apparatus along the operation axis A. A display axis C indicated by A of FIG. 7 is an example of a display axis in which a part of the display axis is a curved line. Further, B illustrated in FIG. 7 indicates an example of a method of showing the display objects displayed on the display surface when the display axis is the display axis C illustrated in FIG. 7.

For example, as described with reference to FIG. 2, there is a concern that the operability of the user may deteriorate, for example, when the operation axis A and the display axis are perpendicular to each other, as in the display axis A of FIG. 7. Accordingly, for example, as indicated by P1 of B of FIG. 7, the display control apparatus according to the present embodiment displays some display objects among the display objects displayed on the display surface so that the display objects have no vertical direction component with respect to the display surface. Further, the display control apparatus according to the present embodiment displays other display objects among the display objects displayed on the display surface so that the other display objects have the vertical direction component with respect to the display surface, for example, as indicated by P2 of B of FIG. 7.

For example, by curving a part of the display axis corresponding to the trajectory according to the present embodiment), for example, as in the display axis C indicated by A of FIG. 7, the user viewing the display objects displayed on the display surface indicated by B of FIG. 7 can more intuitively recognize that an operation direction a illustrated in FIG. 7 corresponds to a movement direction h illustrated in FIG. 3 and an operation direction b illustrated in FIG. 7 corresponds to a movement direction g illustrated in FIG. 7. As described above, since the user can more intuitively recognize the operation direction and the movement direction, for example, a change in display content on the display surface occurring as the result of the operation performed by the user is prevented from not being a change desired by the user.

Accordingly, for example, since the display control apparatus according to the present embodiment “displays some display objects among the display objects displayed on the display surface so that the display objects have no vertical direction component with respect to the display surface and displays other display objects among the display objects displayed on the display surface so that the display objects have the vertical direction component with respect to the display surface,” the display control apparatus according to the present embodiment can promote an improvement in the operability of the user.

The display axis relevant to the second example of the display control process according to the present embodiment is not limited to the display axis of which a part is curved, as in the display axis C indicated by C of FIG. 7. For example, the display axis relevant to the second example of the display control process according to the present embodiment may be a display axis in which a part of the display axis is bent (for example, a display axis in which a part of the display axis has no vertical direction component with respect to the display surface and another part of the display axis has the vertical direction component with respect to the display surface.

When a part of the display axis is bent, “displaying some display objects among the display objects displayed on the display surface so that the display objects have no vertical direction component with respect to the display surface and displaying other display objects among the display objects displayed on the display surface so that the other display objects have the vertical direction component with respect to the display surface” is also realized for the user, as in the case in which the display axis is the display axis C indicated by A of FIG. 7. Accordingly, for example, when the part of the display axis is a bent display axis, the user can more intuitively recognize the operation direction and the movement direction, as in the case in which the display axis is the display axis C indicated by A of FIG. 7.

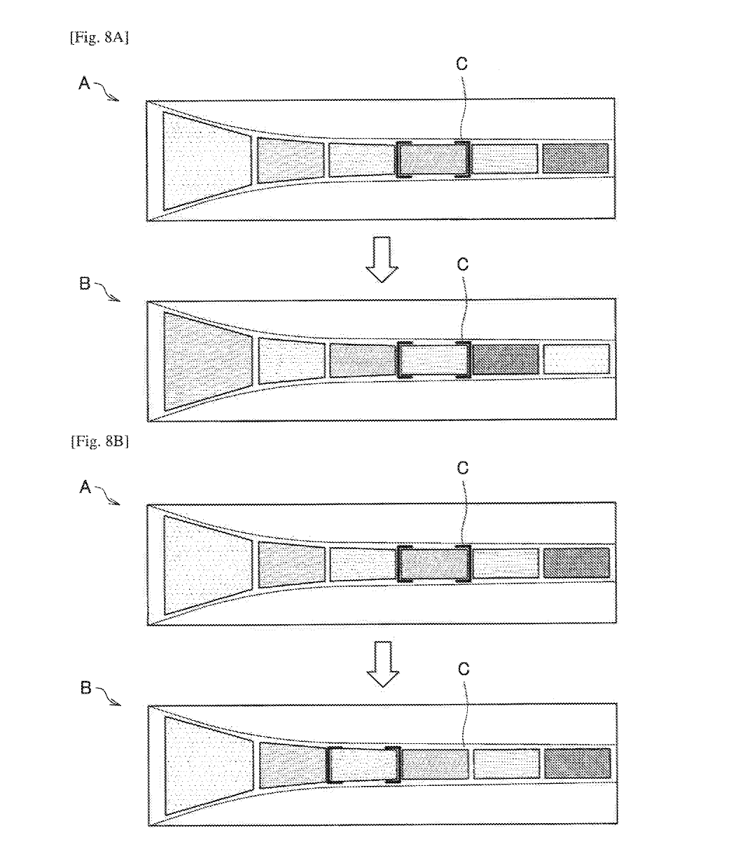

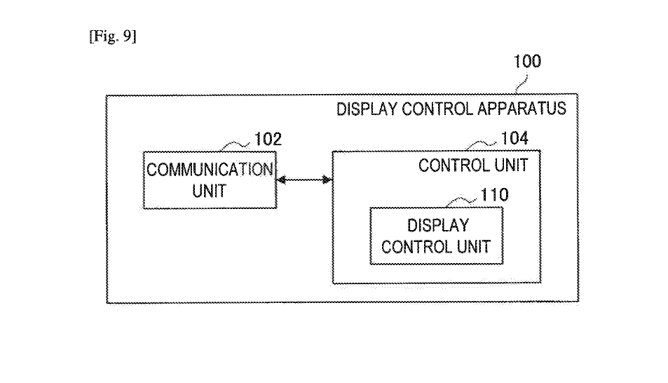

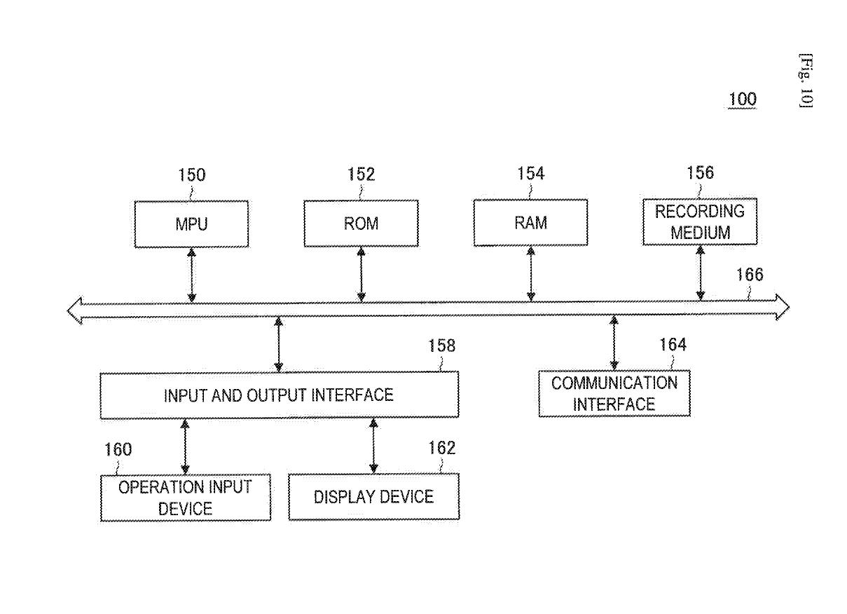

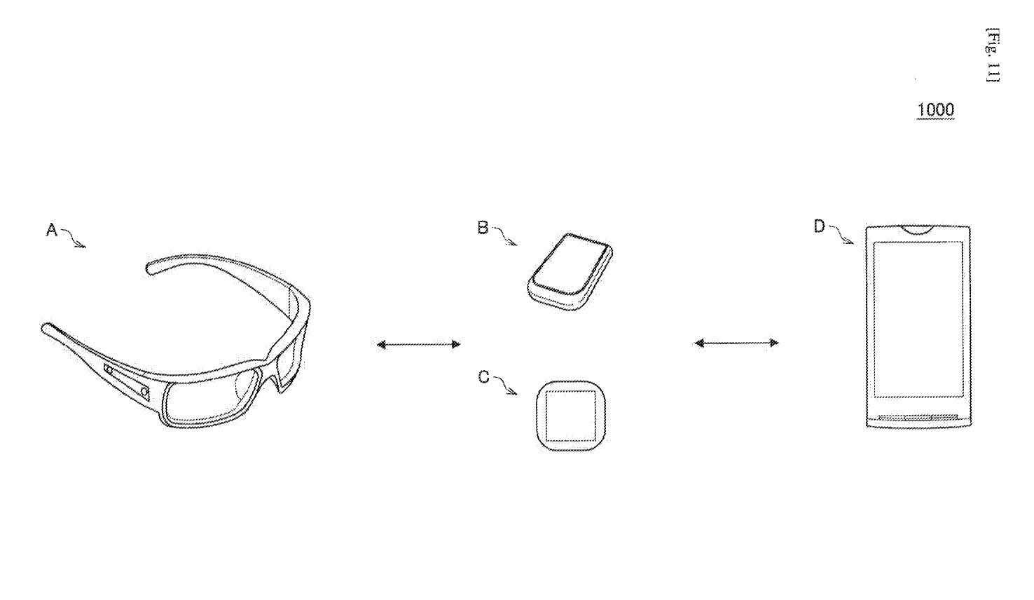

FIGS. 8A and 8B are explanatory diagrams illustrating the second example of the display control process according to the present embodiment in the display control apparatus according to the present embodiment. Here, FIGS. 8A and 813 each illustrate an example of a change in the display content according to a user's operation in the showing method indicated by B of FIG. 7.

For example, as indicated by A and B of FIG. 8A, the display control apparatus according to the present embodiment may move the display objects in the direction of the display axis corresponding to an operation signal according to a user's operation while the position of the cursor C indicating a selected display object remains fixed.

For example, as indicated by A and B of FIG. 8B, the display control apparatus according to the present embodiment may move the cursor C indicating the selected display object in the direction of the display axis corresponding to the operation signal according to the user's operation.

A change in the display content corresponding to the operation signal according to the user's operation is not limited to FIGS. 8A and 8B. For example, the display control apparatus according to the present embodiment may display each of the display objects displayed on the display surface as a 3-dimensional image formed by aright-eye image corresponding to the right eye of the user and a left-eye image corresponding to the left eye of the user and may change convergence of each display object.

### (iii) Third Example of Display Control Process According to Embodiment

An example of the display control process according to the present embodiment in the display control apparatus according to the present embodiment is not limited to the foregoing first example and the foregoing second example.

For example, when the operation device installed at the position of the side of the user in the display control apparatus according to the present embodiment is installed on the right side of the user at the time of the mounting on the user, the display control apparatus according to the present embodiment controls the display of the display objects, for example, such that the trajectory according to the present embodiment is changed in a reverse side (the right side when viewed by the user on which the display apparatus according to the present embodiment is mounted) to the side in FIGS. 3 and 7 based on an acquired operation signal. Here, for example, the display control apparatus according to the present embodiment performs the same process as the foregoing first example and the foregoing second example.

For example, when the operation devices installed at positions of the sides of the user in the display apparatus according to the present embodiment are installed on both sides, i.e., the right side and the left side, of the user at the time of the mounting on the user, the display control apparatus according to the present embodiment controls the display of the display objects such that the trajectory according to the present embodiment is changed to the side corresponding to the operation device from which an operation signal is acquired based on the acquired operation signal. For example, when an operation signal corresponding to the operation device installed on the left side of the user at the time of the mounting on the user is acquired, for example, the display control apparatus according to the present embodiment controls the display of the display objects such that the trajectory according to the present embodiment is changed to the side (the left side when viewed by the user on which the display apparatus according to the present embodiment is mounted) illustrated in FIGS. 3 and 7 based on the acquired operation signal. Further, for example, when an operation signal corresponding to the operation device installed on the right side of the user at the time of the mounting on the user is acquired, for example, the display control apparatus according to the present embodiment controls the display of the display objects such that the trajectory according to the present embodiment is changed to the reverse side (the right side when viewed by the user on which the display apparatus according to the present embodiment is mounted) to the side in FIGS. 3 and 7 based on the acquired operation signal.

When the operation signal acquired in response to the detection in the operation unit 12 is acquired, the display control apparatus according to the present embodiment displays at least some display objects among the display objects displayed on the display surface so that the display objects have the vertical direction component with respect to the display surface, for example, by performing the process relevant to the first example described in the foregoing (i), the process relevant to the second example described in the foregoing (ii), or the process relevant to the third example described in the foregoing (iii).

The display control process according to the present embodiment in the display control apparatus according to the present embodiment is not limited to “the process of displaying at least some display objects among the display objects displayed on the display surface so that the display objects have the vertical direction component with respect to the display surface.”

For example, when an operation signal acquired in response to the detection in the operation unit 12 is not acquired, the display control apparatus according to the present embodiment controls the display of the display objects such that the entire trajectory along which the display objects are moved indicates the trajectory having no vertical direction component with respect to the display surface. That is, for example, when an operation signal acquired in response to the detection in the operation unit 12 is acquired, the display control apparatus according to the present embodiment controls the display of the display objects such that the entire trajectory along which the display objects are moved indicates the trajectory having the vertical direction component with respect to the display surface. The display control apparatus according to the present embodiment displays all of the display objects displayed on the display surface so that all of the display objects have no vertical direction component with respect to the display surface, for example, by controlling the display of the display objects such that the display axis indicates the trajectory parallel to the display surface, as in the display axis A illustrated in FIG. 2.

For example, as illustrated in FIG. 3 or 7, the display control apparatus according to the present embodiment may control the display of the display objects such that at least a part of the trajectory along which the display objects are moved indicates the trajectory having the vertical direction component with respect to the display surface, and then may return the display of the display objects to the state before the control when an operation signal is not acquired in a set predetermined time. Here, for example, the predetermined time may be a fixed time set in advance or may be a variable time settable by the user.

For example, when the display control apparatus according to the present embodiment controls the display of the display objects such that the trajectory according to the present embodiment is changed from the trajectory corresponding to the display axis A illustrated in FIG. 3 to the trajectory corresponding to the display axis B illustrated in FIG. 3, the display control apparatus according to the present embodiment controls the display of the display objects such that the trajectory according to the present embodiment is returned from the trajectory corresponding to the display axis B illustrated in FIG. 3 to the trajectory corresponding to the display axis A illustrated in FIG. 3. Further, for example, when the display control apparatus according to the present embodiment controls the display of the display object such that the trajectory according to the present embodiment is changed from the trajectory corresponding to the display axis A illustrated in FIG. 7 to the trajectory corresponding to the display axis C illustrated in FIG. 7, the display control apparatus according to the present embodiment controls the display of the display objects such that the trajectory according to the present embodiment is returned from the trajectory corresponding to the display axis C illustrated in FIG. 7 to the trajectory corresponding to the display axis A illustrated in FIG. 7.

For example, as described above, based on an acquisition state of the operation signal acquired in response to the detection in the operation unit 12, the display control apparatus according to the present embodiment selectively controls the display of the display objects such that at least a part of the trajectory along which the display objects are moved indicates the trajectory having the vertical direction component with respect to the display surface.

The display control apparatus according to the present embodiment controls the display of the display objects based on the acquisition state of “the operation signal acquired in response to the detection in the operation device installed at the position of the side of the user in the display apparatus,” for example, as described above, in the display control process according to the present embodiment.

An operation signal processed by the display control apparatus according to the present embodiment is not limited to, for example, “the operation signal acquired in response to the detection in the operation device installed at the position of the side of the user in the display apparatus” as in the operation signal acquired in response to the detection in the operation unit 12. For example, the display control apparatus according to the present embodiment may process an operation signal acquired in response to the detection in an operation device other than the operation device (or an external operation device connected at a position of a side of the user; the same applies below) installed at a position of a side of the user in the display apparatus.

Here, a wearable operation device mounted on the body of a user such as an arm of a user for use, an external operation device such as a remote controller, or a communication apparatus such as a smartphone operable by a user can be exemplified as “the operation device other than the operation device installed at the position of the side of the user in the display apparatus” according to the present embodiment. A specific example of “the operation device other than the operation device installed at the position of the side of the user in the display apparatus” according to the present embodiment will be described in a display system according to the present embodiment to be described below. An example of a user's operation on “the operation device other than the operation device installed at the position of the side of the user in the display apparatus” according to the present embodiment will be described below in “Example of operation in display system 1000.”

When an operation signal acquired in response to the detection in “the operation device other than the operation device installed at the position of the side of the user in the display apparatus” according to the present embodiment is acquired, for example, the display control apparatus according to the present embodiment does not display the display objects so that at least a part of the trajectory along which the display objects are moved indicates the trajectory having the vertical direction component on the display surface. In the foregoing case, for example, the display control apparatus according to the present embodiment displays all of the display objects displayed on the display surface so that all of the display objects have no vertical direction component with respect to the display surface by controlling the display of the display objects such that the display axis indicates a trajectory parallel to the display surface, as in the display axis A illustrated in FIG. 2.

Here, for example, the display control apparatus according to the present embodiment identifies the operation device corresponding to the acquired operation signal based on identification information (for example, data indicating an ID) indicating the operation device and included in the operation signal. The method of identifying the operation device according to the acquired operation signal is not limited to the foregoing method. For example, the display control apparatus according to the present embodiment may identify the operation device corresponding to the acquired operation signal based on an acquisition path (for example, an operation signal delivered from the included operation unit 12 or an operation signal received by a communication unit (to be described below)) of the operation signal.

For example, as described above, the display control apparatus according to the present embodiment can change the method of displaying the display objects displayed on the display surface, the method of moving the display objects, or the like according to the operation device corresponding to the operation signal.

### Display Control Apparatus According to Embodiment

Next, an example of the configuration of the display control apparatus according to the present embodiment capable of performing the process relevant to the display control method according to the present embodiment described above will be described.

FIG. 9 is a block diagram illustrating an example of the configuration of a display control apparatus 100 according to the present embodiment. The display control apparatus 100 includes, for example, a communication unit 102 and a control unit 104.

The display control apparatus 100 may include, for example, a read-only memory (ROM; not illustrated), a random access memory (RAM; not illustrated), a storage unit (not illustrated), an operation unit (not illustrated) operable by a user, and a display unit (not illustrated) that displays various screens as a display screen. In the display control apparatus 100, for example, the foregoing constituent elements are connected via a bus serving as a data transmission path.

Here, the ROM (not illustrated) stores a program used by the control unit 104 or control data such as a calculation parameter. The RAM (not illustrated) temporarily stores a program or the like executed by the control unit 104.

The storage unit (not illustrated) is a storage unit included in the display control apparatus 100 and stores, for example, data indicating display objects and various kinds of data such as applications. Here, a magnetic recording medium such as a hard disk or a non-volatile memory such as an electrically erasable and programmable read-only memory (EEPROM) or a flash memory can be exemplified as the storage unit (not illustrated). The storage unit (not illustrated) may be detachably mounted on the display control apparatus 100.

### Example of Hardware Configuration of Display Control Apparatus 100

FIG. 10 is an explanatory diagram illustrating an example of a hardware configuration of the display control apparatus 100 according to the present embodiment. The display control apparatus 100 includes, for example, an MPU 150, a ROM 152, a RAM 154, a recording medium 156, an input and output interface 158, an operation input device 160, a display device 162, and a communication interface 164. In the display control apparatus 100, for example, the constituent elements are connected via a bus 166 serving as a data transmission path.

The MPU 150 is formed by, for example, an MPU or a various processing circuits and functions as the control unit 104 that controls the entire display control apparatus 100. For example, the MPU 150 serves as a display control unit 110 to be described below in the display control apparatus 100.

The ROM 152 stores a program used by the MPU 150, control data such as a calculation parameter, or the like. For example, the RAM 154 temporarily stores a program or the like executed by the MPU 150.

The recording medium 156 functions as a storage unit (not illustrated) and, for example, stores data indicating display objects or various data such as applications. Here, a magnetic recording medium such as a hard disk or a non-volatile memory such as a flash memory can be exemplified as the recording medium 156. Further, the recording medium 156 may he detachably mounted on the display control apparatus 100.

For example, the input and output interface 158 connects the operation input device 160 to the display device 162. The operation input device 160 functions as an operation unit (not illustrated) and the display device 162 functions as a display unit (not illustrated). Here, a Universal Serial Bus (USB) terminal, a Digital Visual Interface (DVI) terminal, a High-Definition Multimedia interface (HDMI) terminal, and various processing circuits can be exemplified as the input and output interface 158. For example, the operation input device 160 can be provided on the display control apparatus 100 and is connected to the input and output interface 158 inside the display control apparatus 100. A button, a direction key, a rotation type selector such as a jog dial, or a combination thereof can be exemplified as the operation input device 160. For example, the display device 162 is provided on the display control apparatus 100 and is connected to the input and output interface 158 inside the display control apparatus 100. A liquid crystal display (LCD) or an organic electro-luminescence (EL) display (or called an organic light emitting diode (OLED) display) can be exemplified as the display device 162.

The input and output interface 158 is, of course, connected to an operation input device (for example, a keyboard or a mouse) which is an external device of the display control apparatus 100 or an external device such as a display device. For example, the display device 162 may be a device such as a touch screen in which a display process and a user's operation can be performed.

The communication interface 164 is a communication unit included in the display control apparatus 100 and functions as the communication unit 102 that performs wireless/wired communication with an external apparatus such as a display apparatus according to the present embodiment via a network (or directly). Here, a communication antenna, an RF circuit (wireless communication), an IEEE 802.15.1 port and a transmission and reception circuit (wireless communication), an IEEE 802.11b port and a transmission and reception circuit (wireless communication), or a LAN terminal and a transmission and reception circuit (wired communication) can be exemplified as the communication interface 164. A wired network such as a LAN or a wide area network (WAN), a wireless network such as a wireless local area network (WLAN) or a wireless wide area network (WWAN) via a base station, or the Internet using a communication protocol such as the transmission control protocol/internet protocol (TCP/IP) can be exemplified as the network according to the present embodiment.

The display control apparatus 100 has, for example, the configuration illustrated in FIG. 10 to perform a process relevant to the display control method according to the present embodiment. The hardware configuration of the display control apparatus 100 according to the present embodiment is not limited to the configuration illustrated in FIG. 10.

For example, the display control apparatus 100 may include a plurality of communication interfaces for which communication schemes differ or communication schemes are the same.

For example, when communication is performed with an external apparatus such as the display apparatus according to the present embodiment via an external communication device connected via the input and output interface 158 or the like, the display control apparatus 100 may not include the communication interface 164.

For example, when the display control apparatus 100 is configured to perform a process as a stand-alone apparatus (for example, when the display control apparatus 100 and the display apparatus according to the present embodiment are an integrated apparatus), the display control apparatus 100 may not include the communication interface 164.

The display control apparatus 100 may have a configuration in which the operation input device 160 or the display device 162 is not included.

Referring back to FIG. 9, an example of the configuration of the display control apparatus 100 will be described. The communication unit 102 is a communication unit included in the display control apparatus 100 and performs wireless/wired communication with an external apparatus such as the display apparatus according to the present embodiment via a network (or directly). The communication of the communication unit 102 is controlled by, for example, the control unit 104.

Here, a communication antenna and an RF circuit or a LAN terminal and a transmission and reception circuit can be exemplified as the communication unit 102, but the configuration of the communication unit 102 is not limited to the foregoing configuration. For example, the communication unit 102 may have a configuration of a USB terminal and a transmission and reception circuit, which corresponds to any standard capable of performing communication or any configuration capable of performing communication with an external apparatus via a network.

The control unit 104 includes, for example, an MPU and serves to control the entire display control apparatus 100. The control unit 104 includes, for example, the display control unit 110 and serves to initiatively perform the process relevant to the display control method according to the present embodiment.

The display control unit 110 serves to initiatively perform the process relevant to the display control method according to the present embodiment and controls the display of the display objects displayed on the display surface in the display apparatus according to the present embodiment (a display apparatus which is mounted on a user so that a display surface is located in front of the user and in which an operation device is installed at a position of a side of the user on which the display apparatus is mounted). For example, the display control unit 110 controls the display of the display objects such that at least a part of the trajectory along which the display objects are moved indicates the trajectory having the vertical direction component with respect to the display surface based on an operation signal acquired in response to the detection in the operation device installed at the position of the side of the user on which the display apparatus according to the present embodiment is mounted.

Here, when the display control apparatus 100 and the display apparatus according to the present embodiment are separate apparatuses, for example, the display control unit 110 performs the process relevant to the display control method according to the present embodiment based on the operation signal received by the communication unit 102. In the foregoing case, for example, the display control unit 110 controls the display of the display objects in the display apparatus corresponding to the embodiment by causing the communication unit 102 to transmit the display control signal according to the processing result to the display apparatus according to the present embodiment.

When the display control apparatus 100 and the display apparatus according to the present embodiment are an integrated apparatus, for example, the display control unit 110 performs the process relevant to the display control method according to the present embodiment based on the operation signal delivered from the operation unit 12. In the foregoing case, for example, the display control unit 110 controls the display of the display objects in the display apparatus according to the present embodiment by delivering the display control signal corresponding to the processing result to the display unit 10.

The control unit 104 includes, for example, the display control unit 110 to initiatively perform the process relevant to the display control method according to the present embodiment.

The display control apparatus 100 has, for example, the configuration illustrated in FIG. 9 to perform the process (for example, the display control process) relevant to the display control method according to the present embodiment. Accordingly, since the display control apparatus 100 has, for example, the configuration illustrated in FIG. 9, the improvement in the operability of the user is promoted.

The configuration of the display control apparatus according to the present embodiment is not limited to the configuration illustrated in FIG. 9.

For example, the display control apparatus according to the present embodiment can separately include the display control unit 110 illustrated in FIG. 9 (for example, each is realized by an individual processing circuit).

For example, when the display control apparatus according to the present embodiment is configured to perform a process as a stand-alone apparatus (for example, when the display control apparatus and the display apparatus according to the present embodiment are an integrated apparatus), the display control apparatus may not include the communication unit 102.

As described above, the display control apparatus according to the present embodiment performs, for example, the foregoing display control process as the process relevant to the display control method according to the present embodiment. Here, the display control apparatus according to the present embodiment displays all of the display objects displayed on the display surface so that all of the display objects have the vertical direction component with respect to the display surface, for example, as indicated by B of FIG. 4. Further, the display control apparatus according to the present embodiment displays some display objects among the display objects displayed on the display surface so that the display objects have no vertical direction component with respect to the display surface, for example, as indicated by P1 of B of FIG. 7, and displays other display objects among the display objects displayed on the display surface so that the display objects have the vertical direction component with respect to the display surface, for example, as indicated by P2 of B of FIG. 7.

Accordingly, the user viewing the display objects displayed on the display surface can more intuitively recognize the operation direction and the movement direction. Since the user can more intuitively recognize the operation direction and the movement direction, for example, a change in display content on the display surface occurring as the result of the operation performed by the user is prevented from not being a change desired by the user.

Accordingly, the display control apparatus according to present embodiment can promote an improvement in the operability of the user.

The display apparatus according to the present embodiment has been described as an example, but the embodiment is not limited thereto. The embodiment can be applied to, for example, “an apparatus that has any shape and a configuration in which a display surface is located in front of a user and an operation device is located at a side of the user” such as an HMD or an eyeglass (monocle) type apparatus.

The display control apparatus according to the present embodiment has been described as an example, but the embodiment is not limited thereto. The embodiment can be applied to, for example, various apparatuses such as communication apparatuses such as mobile phones or smartphones, video/music reproduction apparatuses (or video/music recording reproduction devices), game devices, computers such as PCs or servers, and display apparatuses such as television receivers. Further, the embodiment can be applied to, for example, the display apparatus according to the present embodiment. Furthermore, the embodiment can also he applied (o, for example, a processing integrated circuit (IC) which can be embedded into the foregoing apparatus or the display apparatus according to the present embodiment.

### Program According to Embodiment

When a computer executes a program (for example, a program capable of performing the process relevant to the display control method according to the present embodiment, such as the display control process according to the present embodiment) causing a computer to function as the display control apparatus according to the present embodiment, an improvement in the operability of the user can be promoted.

### Display System According to Embodiment

Next, a display system according to the present embodiment that includes the display apparatus according to the present embodiment, for example, as indicated by A and B of FIG. 1, and the operation device according to the present embodiment with which an operation can be performed on the display apparatus according to the present embodiment will be described.

FIG. 11 is an explanatory diagram illustrating an example of a display system 1000 according to the present embodiment.

The display system 1000 includes, for example, a display apparatus (A illustrated in FIG. 11) according to the present embodiment, operation apparatuses (B and C illustrated in FIG. 11) according to the present embodiment, and a communication apparatus (D illustrated in FIG. 11), such as a smartphone, which a user can operate. The operation apparatus indicated by B of FIG. 11 is an example of a remote controller (operation device). The operation apparatus indicated by C of FIG. 11 is an example of a wearable operation device mounted on the body of the user for use. An example of a clock type operation device mounted on an arm of a user for use is indicated by C of FIG. 11. Here, for example, the operation apparatuses according to the present embodiment indicated by B and C of FIG. 11 correspond to examples of “operation devices other than the operation device installed at the position of the side of the user in the display apparatus” according to the present embodiment described above. In the display system 1000, for example, the communication apparatus indicated by D of FIG. 11 may serve as “an operation device other than the operation device installed at the position of the side of the user in the display apparatus” according to the present embodiment described above. That is, in the display system 1000, the communication apparatus indicated by D of FIG. 11 can also serve as the operation apparatus according to the present embodiment.

The display apparatus according to the present embodiment has, for example, the configuration (including a modification example) described with reference to FIG. 1. Of course, the configuration of the display apparatus according to the present embodiment is not limited to the configuration described with reference to FIG. 1.

The operation apparatus according to the present embodiment includes, for example, an operation device such as a button or a touch sensor, a control unit (not illustrated), and a communication unit (not illustrated). An example of the operation device included in the operation apparatus according to the present embodiment will he described later.

The control unit (not illustrated) included in the operation device according to the present embodiment includes an MPU or various processing circuits and controls the entire operation apparatus according to the present embodiment. The control unit (not illustrated) included in the operation apparatus according to the present embodiment controls the communication unit (not illustrated) included in the operation apparatus according to the present embodiment or communication in a connected external communication device and transmits, for example, an operation signal acquired in response to the detection in the operation device to the display apparatus according to the present embodiment or an external apparatus such as the communication apparatus indicated by D of FIG. 11.

The communication unit (not illustrated) included in the operation apparatus according to the present embodiment serves to perform wireless/wired communication with an external apparatus such as the display apparatus according to the present embodiment. A communication antenna and an RF circuit (wireless communication) or an IEEE 802.15.1 port and a transmission and reception circuit (wireless communication), an IEEE 802.11b port and a transmission and reception circuit (wireless communication), or a LAN terminal and a transmission and reception circuit (wired communication) can be exemplified as the communication unit (not illustrated) included in the operation apparatus according to the present embodiment.

The configuration of the operation apparatus according to the present embodiment is not limited to the foregoing configuration.

For example, when communication is configured to be performed with an external apparatus such as the display apparatus according to the present embodiment via a connected external communication device, the operation apparatus according to the present embodiment may not include the communication unit (not illustrated).

The operation apparatus according to the present embodiment may include, for example, a battery (not illustrated) that supplies power to each device. Here, a secondary battery such as a lithium-ion battery can be exemplified as the battery (not illustrated) included in the operation apparatus according to the present embodiment. When the operation apparatus according to the present embodiment receives power from an external power supply such as a commercial power supply to be driven, the operation apparatus according to the present embodiment may not include a battery (not illustrated).

The display system 1000 includes, for example, the display apparatus according to the present embodiment having the foregoing configuration and the operation apparatus according to the present embodiment having the foregoing configuration. The configuration of the display system according to the present embodiment is not limited to the configuration illustrated in FIG. 11.

For example, the display system according to the present embodiment may not include the communication apparatus, which is indicated by D of FIG. 11, that the user can operate.

In FIG. 11, two apparatuses, i.e., the remote controller indicated by B of FIG. 11 and the wearable operation device indicated by C of FIG. 11, are illustrated as the operation apparatuses according to the present embodiment, but the operation apparatuses according to the present embodiment included in the display system according to the present embodiment are not limited to the two apparatuses indicated by B and C of FIG. 11. For example, the display system according to the present embodiment may be configured to include one or two or more operation apparatuses according to the present embodiment.

Hereinafter, a display system according to the present embodiment will be described exemplifying the display system 1000 illustrated in FIG. 11.

In the display system 1000, for example, the display on the display surface of the display apparatus according to the present embodiment is controlled based on a user's operation. Here, in the display system 1000, the display on the display surface of the display apparatus according to the present embodiment is controlled, for example, when the user operates the operation device included in the display apparatus according to the present embodiment and the operation device included in the operation apparatus according to the present embodiment.

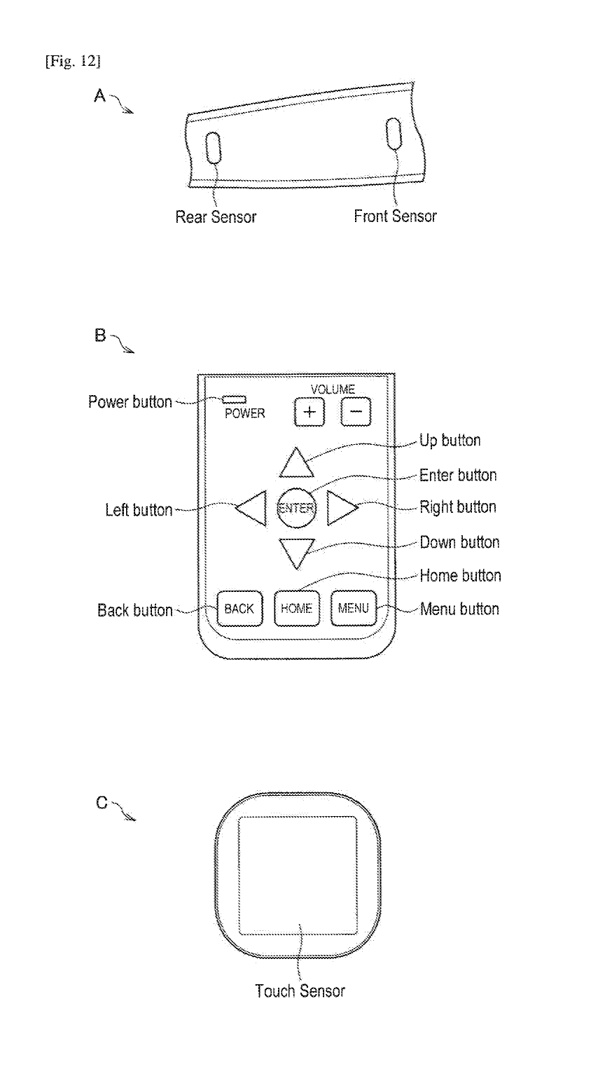

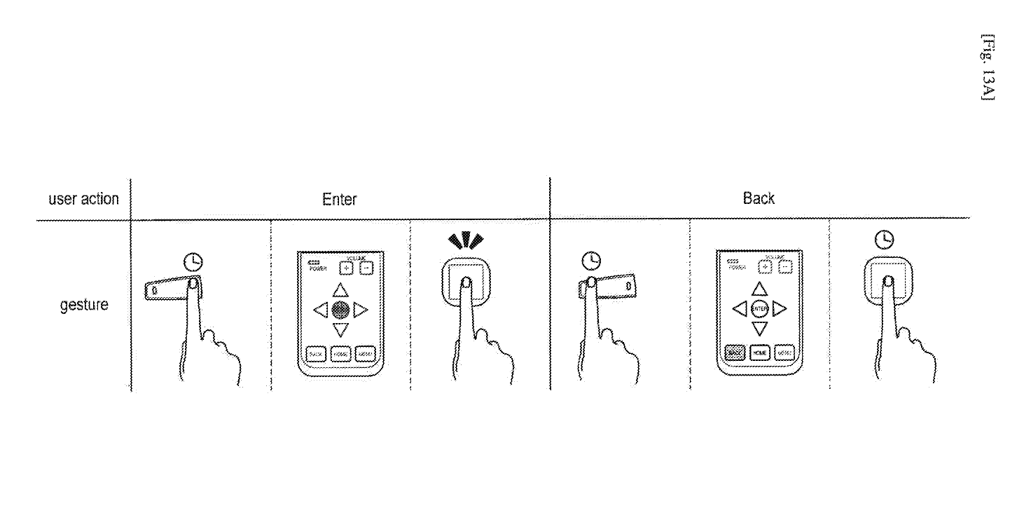

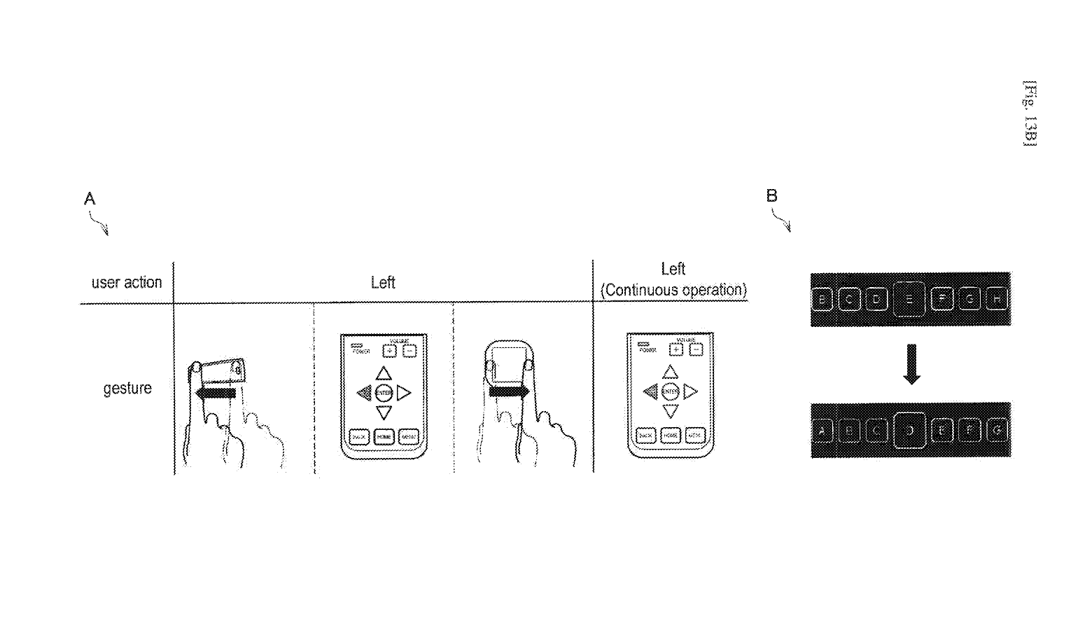

FIG. 12 is an explanatory diagram illustrating an example of an operation device on which an operation relevant to the control of the display on the display surface of the display apparatus according to the present embodiment can be performed in the display system 1000.

A illustrated in FIG. 12 indicates an example of an operation device included in the display apparatus according to the present embodiment and an example in which the operation device is installed at a position on a temple member included in the display apparatus according to the present embodiment. For example, the display apparatus according to the present embodiment includes, as operations devices, a sensor (which is a front sensor indicated by A of FIG. 12 and corresponds to the first sensor 22 indicated by C of FIG. 1) located in front of the user at the time of the mounting on the user and a sensor (which is a rear sensor indicated by A of FIG. 12 and corresponds to the second sensor 24 indicated by C of FIG. 1) located in the rear side of the user at the time of the mounting on the user. Infrared proximity sensors, touch sensors of various types such as an electrostatic capacitance type, or image sensors can be exemplified as the sensors included in the display apparatus according to the present embodiment. The sensors which the display apparatus according to the present embodiment includes as the operation devices are not limited to the example indicated by A of FIG. 12. For example, the operation device included in the display apparatus according to the present embodiment may be a sensor in which the sensor located in front of the user at the time of the mounting on the user and the sensor located on the rear side of the user at the time of the mounting on the user are integrated.

B illustrated in FIG. 12 indicates an example of the operation device included in the remote controller (which is an example of the operation apparatus according to the present embodiment) indicated by B of FIG. 11. The remote controller includes, for example, various buttons as operation devices, as indicated by B of FIG. 12.

C illustrated in FIG. 12 indicates an example of an operation device included in the wearable operation device (which is an example of the operation apparatus according to the present embodiment) indicated by C of FIG. 11. The wearable operation device includes, for example, a touch sensor of various types such as an electrostatic capacitance type as the operation device, as indicated by C of FIG. 12.

Of course, examples of the operation devices included in the display apparatuses according to the present embodiment and the operation apparatus according to the present embodiment are not limited to the examples illustrated in FIG. 12.

Hereinafter, an example of an operation in the display system 1000 and an example of display in the display system 1000 will be described exemplifying a case in which an operation device on which an operation relevant to the control of the display on the display surface of the display apparatus according to the present embodiment can be performed is the operation devices indicated by A to C of FIG. 12.

### [I] Example of Operation in Display System 1000

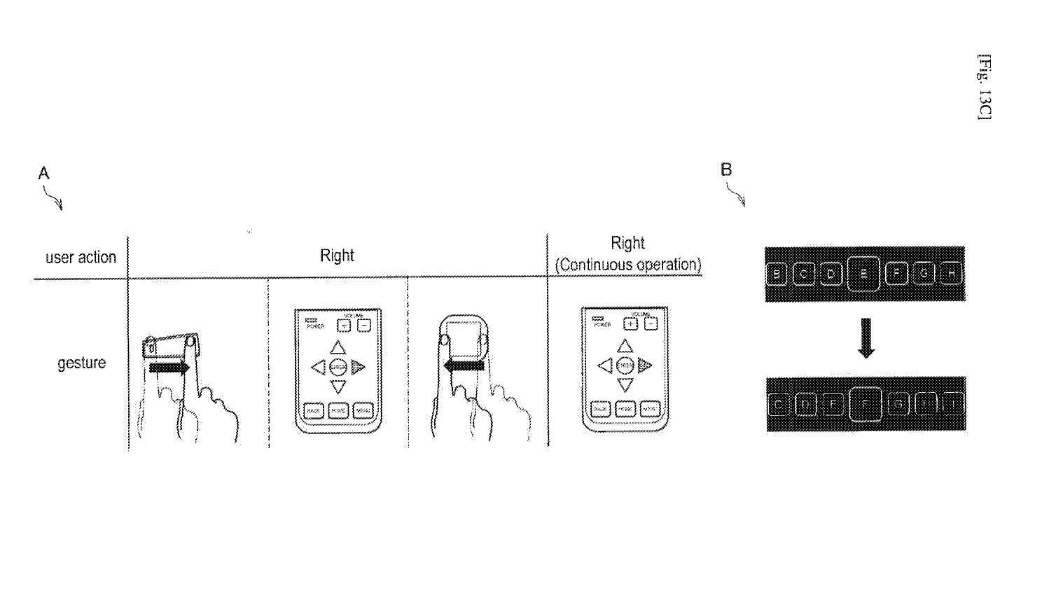

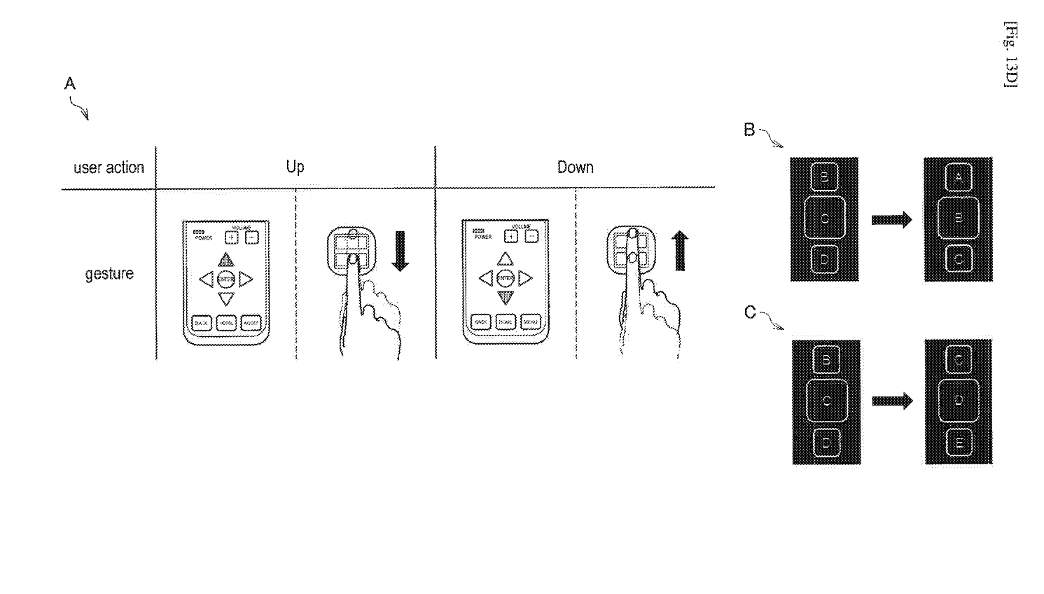

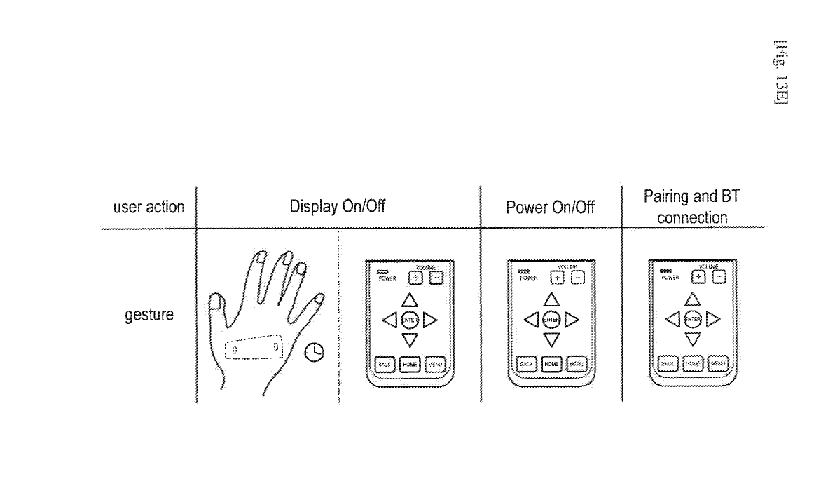

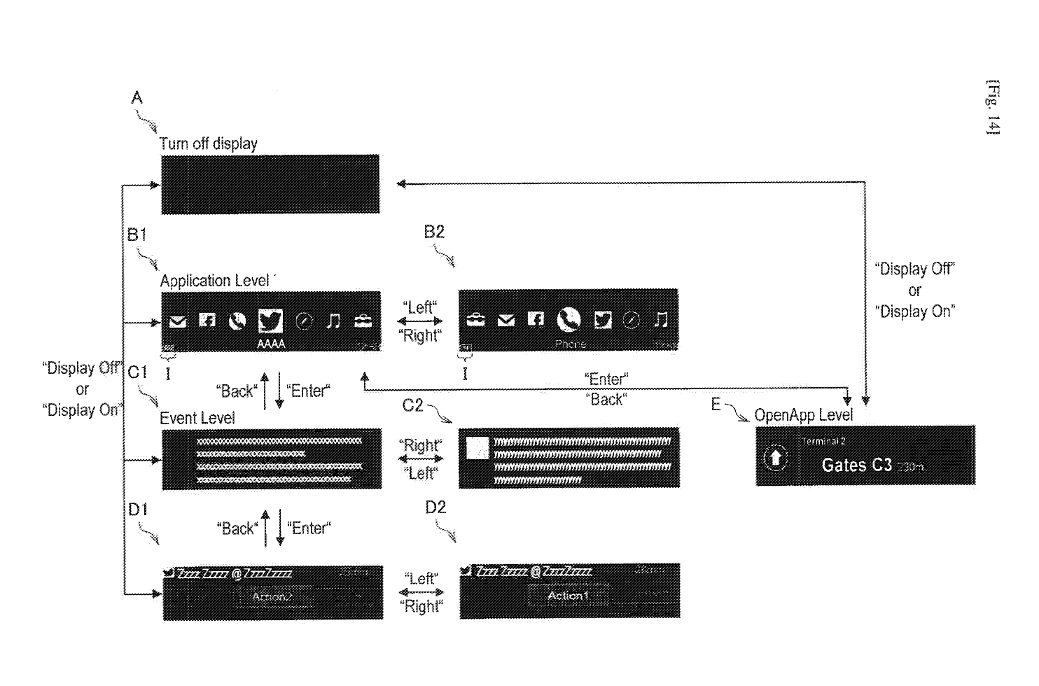

FIGS. 13A to 13E are explanatory diagrams illustrating examples of an operation performed using the operation device in the display system 1000 according to the present embodiment. Here, FIGS. 13A to 13E illustrate examples of correspondence between an operation (a “gesture” illustrated in each drawing) performed by the user and an operation (a “user action illustrated in each drawing) recognized in the display apparatus according to the present embodiment in response to this operation. Of course, examples of the correspondence between an operation performed by the user and an operation recognized in the display apparatus according to the present embodiment in response to this operation are not limited to the examples illustrated in FIGS. 13A to 13E.

FIG. 13A illustrates an example of correspondence between each of “a determination operation (Enter illustrated in FIG. 13A)” and “a return operation or a cancellation operation (Back illustrated in FIG. 13A)” recognized in the display apparatus according to the present embodiment and an operation performed by the user.

For example, when the user performs the following operation, a “determination operation” is recognized in the display apparatus according to the present embodiment:

an operation of touching the sensor included in the display apparatus according to the present embodiment and located on the front side for a time equal to or greater than a predetermined time (or greater than the predetermined time);

an operation of pressing an Enter button included in the remote controller; and an operation of touching the touch sensor of the wearable operation device.

For example, when the user performs the following operation, “a return operation or a cancellation operation” is recognized in the display apparatus according to the present embodiment:

an operation of touching the sensor included in the display apparatus according to the present embodiment and located on the rear side for a time equal to or greater than a predetermined time (or greater than the predetermined time);

an operation of pressing a BACK button included in the remote controller; and

an operation of touching the touch sensor of the wearable operation device for a time equal to or greater than a predetermined time (or greater than the predetermined time).

A illustrated in FIG. 13B indicates an example of correspondence between “an operation (Left illustrated in FIG. 13B) of moving a display object, a cursor, or the like to the left side” recognized in the display apparatus according to the present embodiment and an operation performed by the user. Further, B illustrated in FIG. 13B indicates an example of a change in display content displayed on the display surface as the result recognized in the display apparatus according to the present embodiment.

For example, when the user performs the following operation, “a moving operation to the left” is recognized in the display apparatus according to the present embodiment:

an operation of touching the sensor located on the rear side after the sensor included in the display apparatus according to the present embodiment and located on the front side is touched;

an operation of pressing a Left button included in the remote controller; and

a sliding operation from the left side to the right side on the touch sensor of the wearable operation device.

For example, when the user performs the following operation, “a moving operation to the left side” is continuously recognized in the display apparatus according to the present embodiment:

an operation of continuously pressing the Left button included in the remote controller (which corresponds to a “continuous operation” indicated by A of FIG. 13B).

A illustrated in FIG. 13C indicates an example of correspondence between “an operation (Right illustrated in FIG. 13C) of moving a display object, a cursor, or the like to the right side” recognized in the display apparatus according to the present embodiment and an operation performed by the user. Further, C illustrated in FIG. 13C indicates an example of a change in display content displayed on the display surface as the result recognized in the display apparatus according to the present embodiment.

For example, when the user performs the following operation, “a moving operation to the right side” is recognized in the display apparatus according to the present embodiment:

an operation of touching the sensor located on the front side after touching the sensor included in the display apparatus according to the present embodiment and located on the rear side;

an operation of pressing the Right button included in the remote controller; and a sliding operation from the right side to the left side on the touch sensor of the wearable operation device.

For example, when the user performs the following operation, “a moving operation to the right side” is continuously recognized in the display apparatus according to the present embodiment:

an operation (corresponding to a “continuous operation” indicated by A of F C) of continuously pressing the Right button included in the remote controller.

A illustrated in FIG. 13D indicates an example of correspondence between an operation performed by the user and each of “an operation (Up illustrated in FIG. 13D) of moving a display object, a cursor, or the like to the upper side” and “an operation (Down illustrated in FIG. 13D) of moving the display object, the cursor, or the like to the lower side” recognized in the display apparatus according to the present embodiment. Further, B illustrated in FIG. 13D indicates an example of a change in display content displayed on the display surface as the recognition result of the “moving operation to the upper side” in the display apparatus according to the present embodiment. Furthermore, C illustrated in FIG. 13D indicates an example of a change in display content displayed on the display surface as the recognition result of the “moving operation to the lower side” in the display apparatus according to the present embodiment.

For example, when the user performs the following operation, “the moving operation to the upper side” is recognized in the display apparatus according to the present embodiment:

an operation of pressing an Up button included in the remote controller; and a siding operation from the upper side to the lower side on the touch sensor of the wearable operation device.

For example, when the user performs the following operation, “a moving operation to the lower side” is recognized in the display apparatus according to the present embodiment:

an operation of pressing a Down button included in the remote controller; and a sliding operation from the lower side to the upper side on the touch sensor of the wearable operation device.

FIG. 13E illustrates an example of correspondence between an operation performed by the user and each of “an operation (Display On/Off illustrated in FIG. 13E) of turning on/off the display on the display surface,” “an operation (Power On/Off illustrated in FIG. 13E) of turning on/off power of the display apparatus according to the present embodiment,” and “an operation (Pairing and BT connection illustrated in FIG. 13E) of enabling wireless communication of a predetermined communication scheme to be performed” recognized in the display apparatus according to the present embodiment.

For example, when the user performs the following operation, “an operation of turning on/off the display on the display surface” is recognized in the display apparatus according to the present embodiment:

an operation of touching the sensor included in the display apparatus according to the present embodiment and located on the front side and the sensor located on the rear side for a time equal to or greater than a predetermined time (or greater than the predetermined time); and

an operation of pressing a Power button included in the remote controller for a time equal to or less than a set first time (or less than the first time).

For example, when the user performs the following operation, “an operation of turning on/off the power of the display apparatus according to the present embodiment” in the display apparatus according to the present embodiment is recognized:

an operation of pressing the Power button included in the remote controller for a time longer than the set first time (or equal to or longer than the first time) and equal to or less than the set second time (or less than the second time),

where the first time the second time.

For example, when the user performs the following operation, “the operation of enabling the wireless communication of the predetermined communication scheme to be performed” in the display apparatus according to the present embodiment is recognized:

an operation of pressing the Power button included in the remote controller for a time equal to or less than the out first time (or less than the first time) at the time of the first setting: and

an operation of pressing the Power button included in the remote controller for a time greater than the set second time (or equal to or greater than the second time) and equal to or less than a set third time (or less than the third time),

where the second time <the third time.

### [II] Example of Display in Display System 1000

Next, an example of the display in the display system 1000 realized through, for example, the same user's operations as those illustrated in FIGS. 13A to 13E will be described.

FIG. 14 is an explanatory diagram illustrating an example of display in the display system 1000 according to the present embodiment and illustrates an example of display content displayed on the display surface of the display apparatus according to the present embodiment.

A illustrated in FIG. 14 indicates that the display in the display apparatus according to the present embodiment is in an off-state.

B1 and B2 illustrated in FIG. 14 illustrate examples of reference screens (so-called home screens) displayed on the display surface. For example, as indicated by B I and B2 of FIG. 14, a frame (for example, a frame displayed to surround a display object) indicating a region in which a display object is displayed is not drawn on the reference screens according to the present embodiment. As described above, since the frame indicating the region in which a display object is displayed is not drawn, the user can feel a sense that display objects are floating.

Here, I indicated by B1 and B2 of FIG. 14 is an icon showing a remaining amount of battery power. For example, the icon showing the remaining amount of battery power according to the present embodiment shows a remaining amount of battery power included in the display apparatus according to the present embodiment, but the remaining amount of battery power shown by the icon showing the remaining amount of battery power according to the present embodiment is not limited to the foregoing remaining amount of battery power. For example, an icon showing the remaining amount of battery power according to the present embodiment may also show a remaining amount of battery power included in an external apparatus of the display apparatus according to the present embodiment, such as a remaining amount of battery power included in the operation apparatus according to the present embodiment, a remaining amount of battery power included in the communication apparatus indicated by D of FIG. 11. For example, the display apparatus according to the present embodiment acquires data indicating the remaining amount of battery power from an external apparatus and displays the icon I showing a remaining amount of battery power included in the external apparatus indicated by the acquired data on the display surface.

For example, C1 and C2 illustrated in FIG. 14 indicate examples of screens displayed when display objects are selected on the reference screens indicated by B1 and B2 illustrated in FIG. 14 and corresponding to the selected display objects. Here, when the display indicated by A of FIG. 14 in the display apparatus according to the present embodiment enters the off-state at the time of the display of the screens indicated by C1 and C2 of FIG. 14 and the display in the display apparatus according to the present embodiment enters the on-state again, for example, a screen (the screen indicated by C1 or C2 of FIG. 14) before the off-state is displayed on the display surface of the display apparatus according to the present embodiment.

For example, as indicated by C1 or C2 of FIG. 14, on a screen on which a sentence (“xxx . . . ” and “yyy . . . ” are indicated in C1 and C2 of FIG. 14) is displayed, the entire sentence may not be displayed on the display surface in some cases. When the entire sentence is not displayed on the display surface, as described above, the display apparatus according to the present embodiment presents the entire sentence to the user, for example, by automatic scroll display. The process of the display apparatus according to the present embodiment in the case in which the entire sentence is not displayed on the display surface, as described above, is not limited to the foregoing process. For example, the display apparatus according to the present embodiment may perform scroll display in response to an operation signal based on a user's operation. Further, when the scroll display is performed in response to the operation signal based on the user's operation, for example, the display apparatus according to the present embodiment may not perform automatic scroll display.

For example, D1 and D2 illustrated in FIG. 14 indicate examples of screens displayed at the time of selection of display objects on the screens indicated by C1 and C2 of FIG. 14 and corresponding to the selected display objects. Here, when the display indicated by A of FIG. 14 in the display apparatus according to the present embodiment enters the off-state at the time of the display of the screen indicated by D1 or D2 of FIG. 14 and the display in the display apparatus according to the present embodiment enters the on-state again, for example, a screen (the screens indicated by D1 or D2 of FIG. 14) before the off-state is displayed on the display surface of the display apparatus according to the present embodiment.

For example, E illustrated in FIG. 14 indicates an example of a screen displayed at the time of selection of a display object produced by a third party and corresponding to the selected display object on the reference screen indicted by B1 or B2 illustrated in FIG. 14.

In the display system 1000 according to the present embodiment, for example, transition of the display content illustrated in FIG. 14 is realized through, for example, the user's operations illustrated in FIGS. 13A and 13E.

The transition of the display content realized through, for example, the user's operations illustrated in FIGS. 13A to 13E is not limited to the example illustrated in FIG. 14. Hereinafter, examples of the transition of the display content displayed on the display surface of the display apparatus according to the present embodiment by, for example, the user's operations illustrated in FIGS. 13A to 13E will be described.

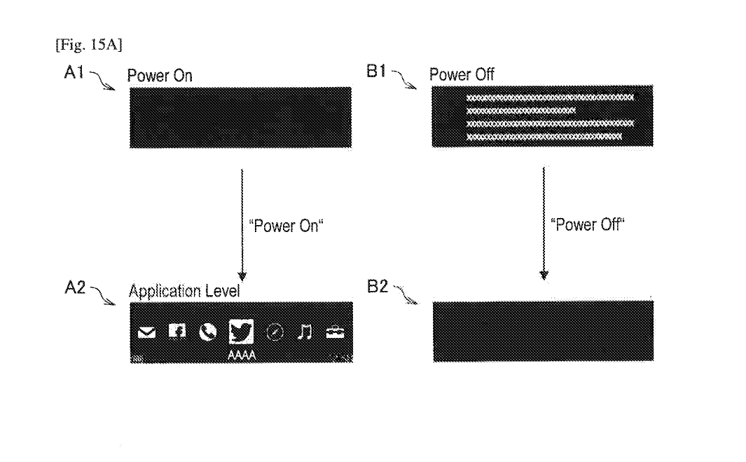

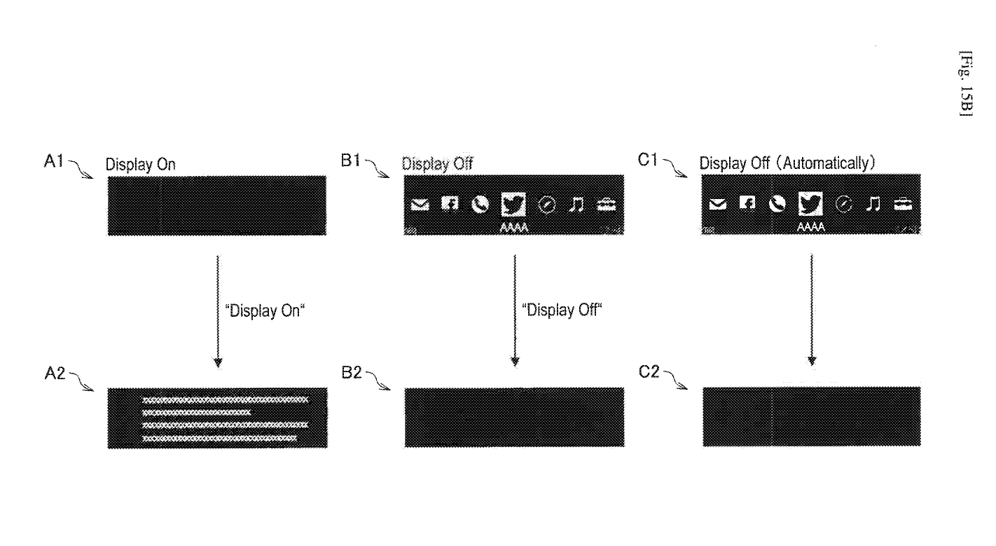

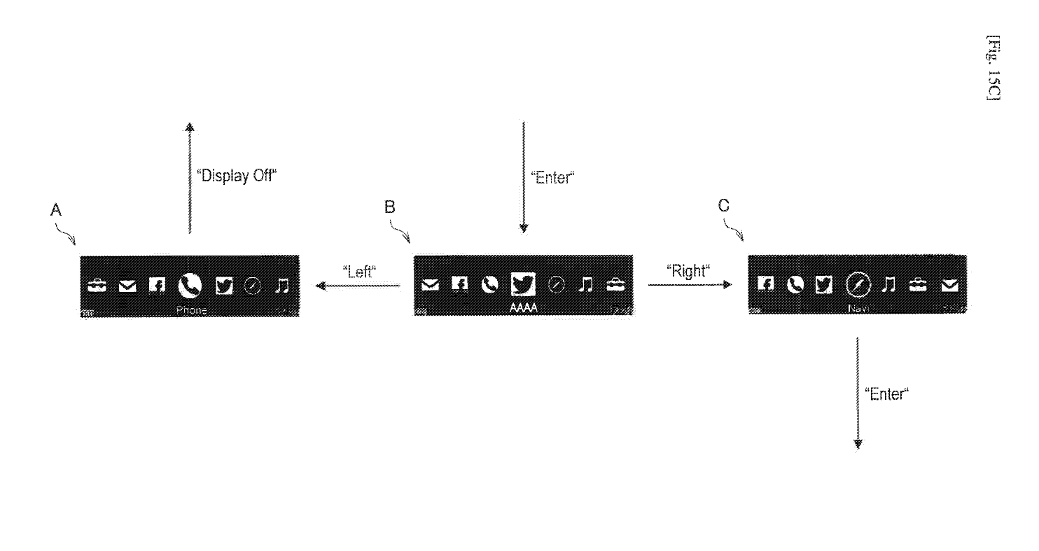

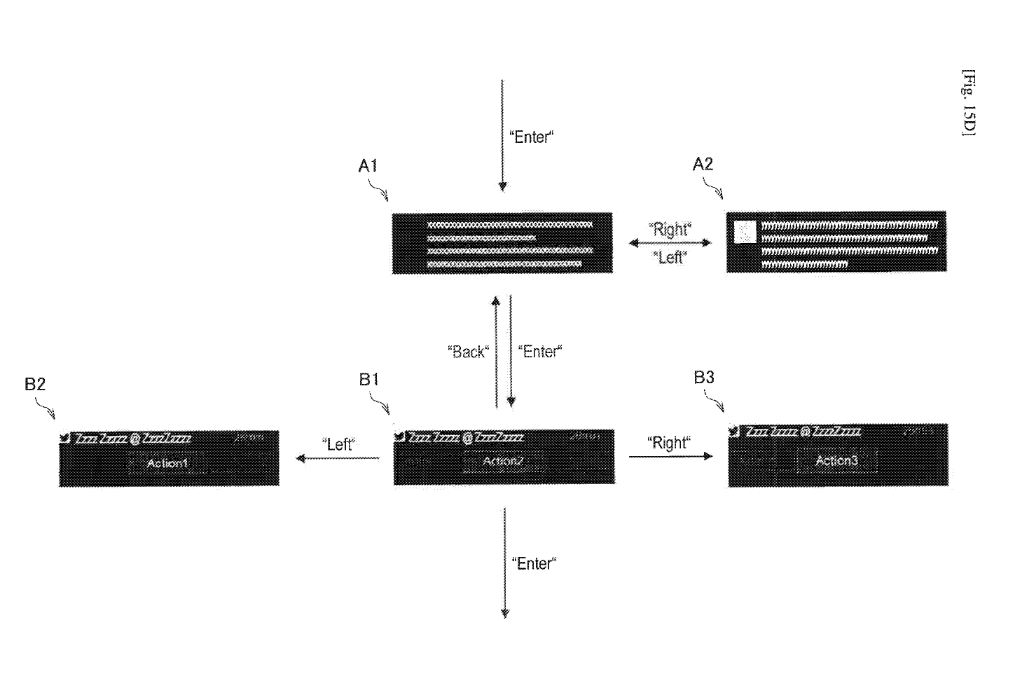

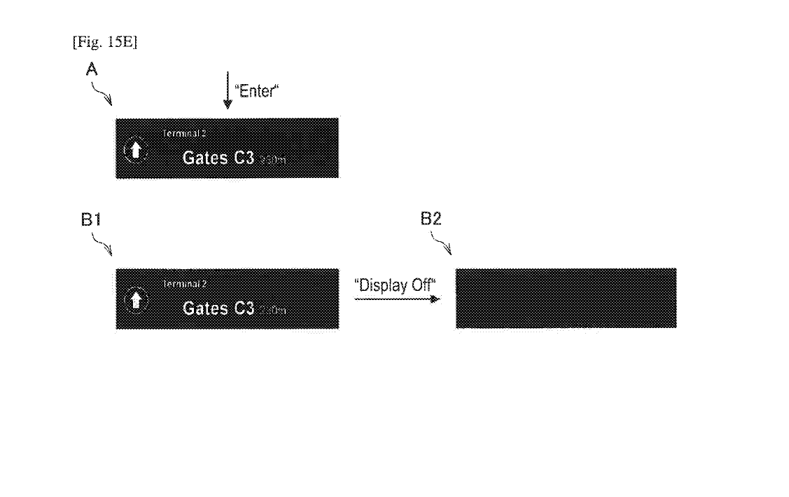

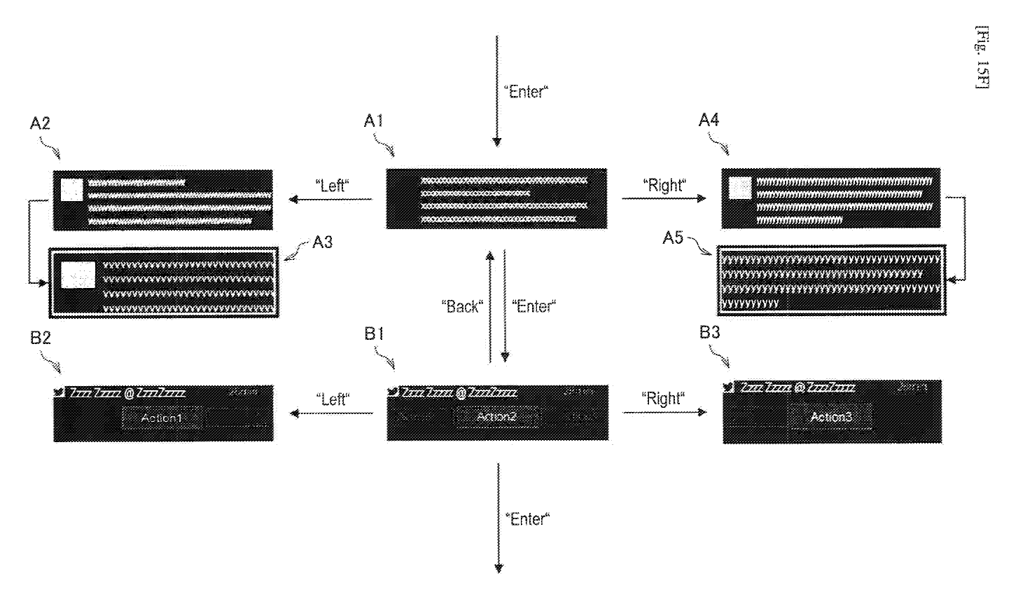

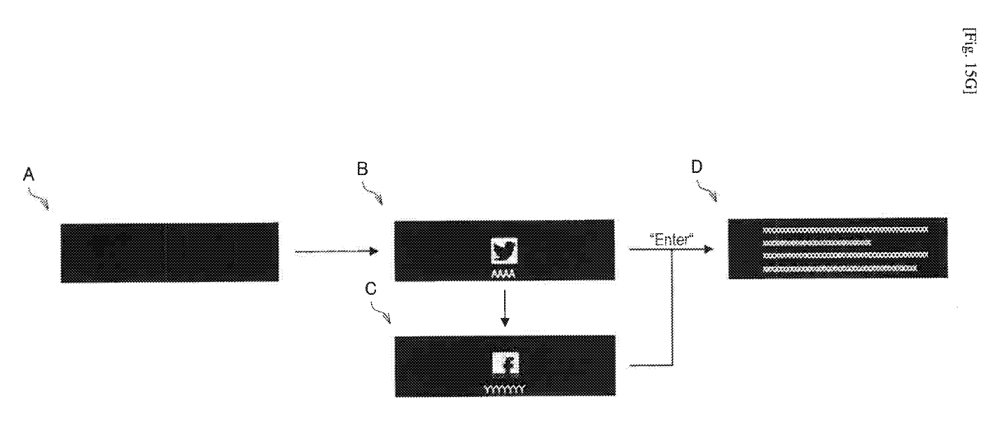

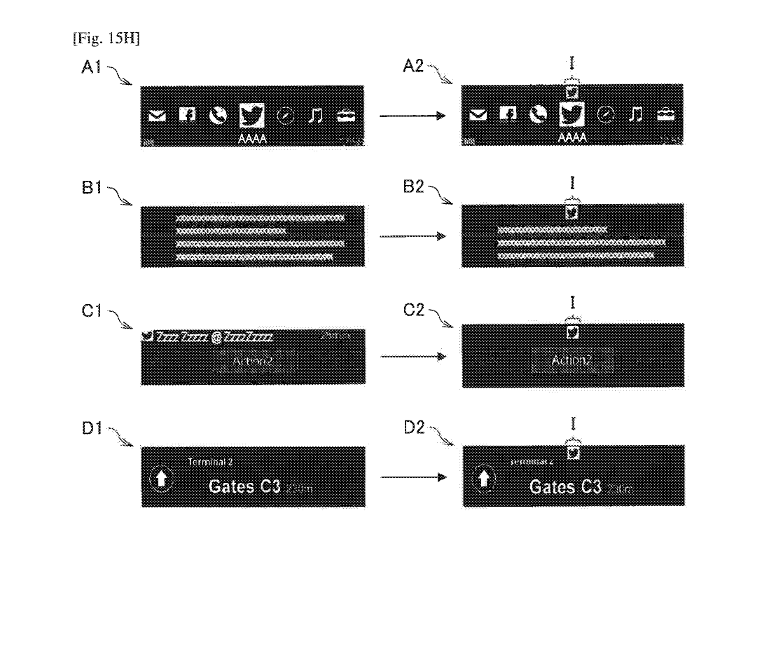

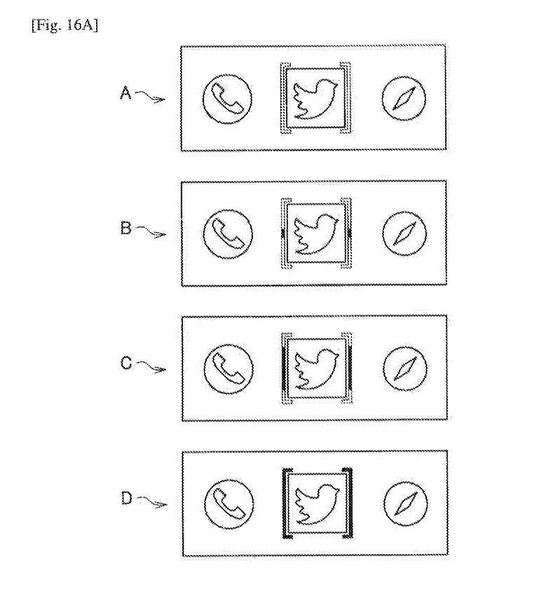

FIGS. 15A to 15H are explanatory diagrams illustrating other examples of the display in the display system 1000 according to the present embodiment and illustrate examples of the display content displayed on the display surface of the display apparatus according to the present embodiment.

FIG. 15A illustrates an example of the transition of the display content when the user performs “an operation of turning on/off the power of the display apparatus according to the present embodiment” illustrated in FIG. 13E.

For example, when the power of the display apparatus according to the present embodiment is in the off-state and “the operation of turning on/off the power of the display apparatus according to the present embodiment” is performed, the display apparatus according to the present embodiment turns on the power based on an operation signal in response to this operation. As a result, for example, the display content on the display surface of the display apparatus according to the present embodiment is changed from a state indicated by Al illustrated in FIG. 15A to a state indicated by A2 illustrated in FIG. 15A.

For example, when the power of the display apparatus according to the present embodiment is in the on-state and “the operation of turning on/off the power of the display apparatus according to the present embodiment” is performed, the display apparatus according to the present embodiment turns off the power based on an operation signal in response to this operation. As a result, for example, the display content on the display surface of the display apparatus according to the present embodiment is changed from a state indicated by B1 illustrated in FIG. 15A to a state indicated by B2 illustrated in FIG. 15A.

FIG. 15B illustrates an example of the transition of the display content when the user performs “an operation of turning on/off the display on the display surface” illustrated in FIG. 13E.

For example, when the display on the display surface of the display apparatus according to the present embodiment is in the off-state and “the operation of turning on/off the display on the display surface” is performed, the display apparatus according to the present embodiment turns on the display on the display surface based on an operation signal in response to this operation. As a result, the display content on the display surface of the display apparatus according to the present embodiment is changed from a state indicated by A1 illustrated in FIG. 15B to a state indicated by A2 illustrated in FIG. 15B.

For example, when the display on the display surface of the display apparatus according to the present embodiment is in the on-state and “the operation of turning on/off the display on the display surface” is performed, the display apparatus according to the present embodiment turns off the display on the display surface based on an operation signal in response to this operation. As a result, for example, the display content on the display surface of the display apparatus according to the present embodiment is changed from a state indicated by B1 illustrated in FIG. 15B to a state indicated by B2 illustrated in FIG. 15B.

For example, when the display on the display surface of the display apparatus according to the present embodiment is turned on and the operation signal in response to “the operation of turning on/off the display on the display surface” is not acquired, the display apparatus according to the present embodiment can automatically turn off the display on the display surface. For example, when the display on the display surface of the display apparatus according to the present embodiment is turned on and no operation signal is acquired even after elapse of a set predetermined time, the display apparatus according to the present embodiment automatically turns off the display on the display surface. When the display on the display surface is automatically turned off, for example, the display content on the display surface of the display apparatus according to the present embodiment is changed from a state indicated by C1 illustrated in FIG. 15B to a state indicated by C2 illustrated in FIG. 15B.

FIG. 15C illustrates examples of the transition of the display content when the various operations illustrated in FIGS. 13A to 13C and 13E are performed on the reference screens indicated by B1 and B2 of FIG. 14. FIG. 15D illustrates examples of the transition of the display content when the various operations illustrated in FIGS. 13A to 13C are performed on the screens indicated by C1, C2, D1, and D2 of FIG. 14. For example, as illustrated in FIGS. 15C and 15D, the display apparatus according to the present embodiment changes the display content on the display surface of the display apparatus according to the present embodiment to content corresponding to an operation based on an operation signal in response to the performed operation. For example, as indicated by A1 and A2 of FIG. 15D, when sentences (“xxx . . . ” and “yyy . . . ” are indicated in Al and A2 of FIG. 15D) are displayed on the screens, as described above, for example, the display apparatus according to the present embodiment may present the entire sentences to the user by automatic scroll display.

A illustrated in FIG. 15E indicates an example of the transition of the display content when the “determination operation” illustrated in FIG. 13A is performed on the display object produced by a third party on the reference screen indicated by B1 or B2 of FIG. 14. Further, B illustrated in FIG, 15E indicates an example of the transition of the display content, for example, when a screen displayed at the time of the selection of the display object produced by the third party and indicated by E of FIG. 14 is displayed and the user performs “the operation of turning on/off the display on the display surface” illustrated in FIG. 13E. For example, as illustrated in FIG. 15E, the display apparatus according to the present embodiment changes the display content on the display surface of the display apparatus according to the present embodiment to content corresponding to the operation based on an operation signal in response to the performed operation.

FIG. 15F illustrates other examples of the transition of the display content when the various operations illustrated in FIGS. 13A to 13C are performed on the screens indicated by C1, C2, D1, and D2 of FIG. 14.

For example, when “the moving operation to the left side” illustrated in FIG. 13B or “the moving operation to the right side” illustrated in FIG. 13C is performed on the screen indicated by A1 of FIG. 15F, for example, the display apparatus according to the present embodiment changes the display content on the display surface to display content indicated by A2 of FIG. 15F or A4 of FIG. 15F. Here, when the display content is transitioned, the display content after the transition can be display content in which “the moving operation to the left side” or “the moving operation to the right side” is not received any more in some cases.

Accordingly, when the display content is the display content in which “the moving operation to the left side” is not received any more, for example, the display apparatus according to the present embodiment changes the display content to be expressed extending in a reverse direction to a direction in which the display content is not moved, for example, as indicated by A3 of FIG. 15F. Further, when the display content is the display content in which “the moving operation to the right side” is not received any more, for example, the display apparatus according to the present embodiment changes the display content to be expressed extending in a reverse direction to a direction in which the display content is not moved, for example, as indicated by A5 of FIG. 15F.

For example, when the display content is displayed on the display surface in the expression way indicated by A3 or A5 of FIG. 15F, the user can recognize that “the moving operation to the left side” or “the moving operation to the right side” is not performable any more. Accordingly, for example, as indicated by A3 and A5 of FIG. 5F, the display apparatus according to the present embodiment displays the display content on the display surface in an expression indicating that an operation is not performable, thereby further improving the operability of the user.

The expression indicating that the operation according to the present embodiment may not be performed is not limited to the examples indicated by A3 and A5 of FIG. 15F. For example, the display apparatus according to the present embodiment may display the display content on the display surface using any expression capable of notifying the user that an operation is not performable, such as “an expression of flashing an end corresponding to the direction in which an operation is not performable any more on the screen” or “an expression of displaying an arrow oriented to a direction in which an operation is performable on the screen.”

For example, in the case of the screens on which sentences (“vvv . . . ,” “xxx . . . ,” and “yyy . . . ” are indicated by Al to AS of FIG. 1SF) are displayed, as indicated by A1 to AS of FIG. 15F, for example, the display apparatus according to the present embodiment may present the entire sentences to the user by automatic scroll display, as described above.

In FIGS. 15A to 15F, the examples in which the display apparatus according to the present embodiment transitions the display content displayed on the display surface based on the operation signal in response to the user's operation have been described. However, the process in the display apparatus according to the present embodiment is not limited to the process of transitioning the display content displayed on the display surface based on the operation signal.

For example, the display apparatus according to the present embodiment may transition the display content displayed on the display surface based on a set trigger such as reception of new mail or reception of a new posting such as a Tweet. Here, the reception of the mail, the posting, or the like may be, for example, reception in the display apparatus according to the present embodiment or may be reception in an external apparatus such as the communication apparatus indicated by D of FIG. 11. For example, the display apparatus according to the present embodiment sets the reception of the mail, the posting, or the like in an external apparatus as the trigger by acquiring data indicating the reception of the mail, the posting, or the like or data such as the received mail, the received posting, or the like from the external apparatus.

FIGS. 15G and 15H illustrate examples of the transition of the display content when a set trigger is detected. Here, FIG. 15G illustrates an example of the transition of the display content when the set trigger is detected at the time of the off-state of the display on the display surface of the display apparatus according to the present embodiment. FIG. 15H illustrates an example of the transition of the display content when the set trigger is detected at the time of the on-state of the display on the display surface of the display apparatus according to the present embodiment.

For example, when the trigger set at the time of the off-state of the display on the display surface is detected, the display apparatus according to the present embodiment changes the display content on the display surface from a state indicated by A of FIG. 15G to a state indicated by B of FIG. 15G corresponding to the detected trigger. Further, when another trigger is detected in the state indicated by B of FIG. 15G the display apparatus according to the present embodiment changes the display content on the display surface from the state indicated by B of FIG. 15G to a state indicated by C of FIG. 15G corresponding to the detected trigger. When an operation signal in response to the “determination operation” indicated by A of FIG. 13 is acquired in the state indicated by B or C of FIG. 15G, the display apparatus according to the present embodiment changes the display content on the display surface from the state indicated by B or C of FIG. 15G to a state indicated by D of FIG. 15G corresponding to the operation signal.

When the trigger set at the time of the on-state of the display on the display surface is detected, the display apparatus according to the present embodiment displays an icon 1 corresponding to the detected trigger on the display surface, for example, as indicated by A2, B2, C2, or D2 of FIG. 15H.

For example, when the icon I corresponding to the detected trigger is displayed on the display surface, the user can recognize reception of new mail, reception of a new posting, or the like. Accordingly, for example, as indicated by A2, B2, C2, or D2 of FIG. 15H, since the display apparatus according to the present embodiment displays the icon I corresponding to the detected trigger on the display surface, the operability of the user can be further improved.

In the display system 1000, for example, as illustrated in FIGS. 14 and 15A to 15H, the display content displayed on the display surface is transitioned based on the operation signal in response to the user's operation illustrated in FIGS. 13A to 13E or the detected trigger.

Examples of the display in the display system 1000 are not limited to the examples illustrated in FIGS. 14 and 15A to 15H. Thus, other examples of the display in the display system 1000 will be described next.

Another example of display in display system 1000

### (i) FIRST EXAMPLE

### Display in which Operation can be Fed Back

When the display apparatus according to the present embodiment included in the display system 1000 is “the display apparatus which is mounted on the user so that the display surface on which display objects can be displayed is located in front of the user and in which the operation device is installed at a position of a side of the user on which the display apparatus is mounted,” for example, as indicated by A and B of FIG. 1 or A of FIG. 11, it is difficult for the user on which the display apparatus according to the present embodiment is mounted to perform an operation while confirming the operation device on the side with his or her eyes. For this reason, for example, an action unintended as an operation by the user, such as an action of searching for the operation device or an action of smoothing hair, is detected by the operation device, and thus a process unintended by the user may be performed in the display apparatus according to the present embodiment. Further, when the process which the user does not intend is performed by the display apparatus according to the present embodiment, as described above, there is a concern that the operability of the user may deteriorate.

Accordingly, when an operation signal is acquired, the display apparatus according to the present embodiment gives feedback to the user to inform the user that the operation signal is acquired. The display apparatus according to the present embodiment performs a process based on an acquired operation signal after a set time passes after start of the feedback.

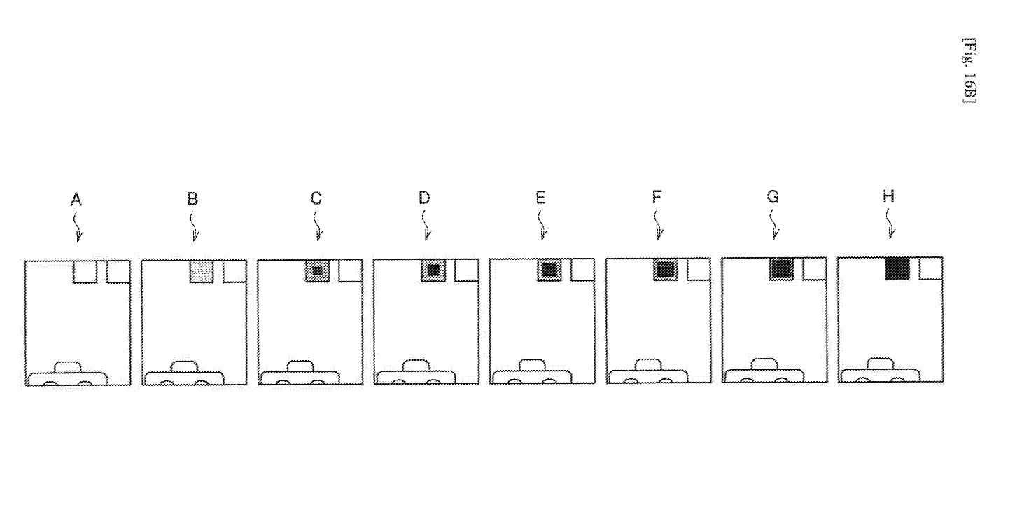

FIGS. 16A and 16B are explanatory diagrams illustrating other examples of the display in the display system 1000 according to the present embodiment and illustrate examples of the display in which an operation corresponding to the acquired operation signal is fed back to the user. Here, A to D illustrated in FIG. 16A indicate a change in the display content displayed on the display surface chronologically in order of A to D. Further, A to H illustrated in FIG. 1613 indicate a change in the display content displayed on the display surface chronologically in order of A to H.

For example, when the “determination operation” on a given display object is recognized, the display apparatus according to the present embodiment changes the display of a focus frame indicating a selected display object, for example, as indicated by B to D of FIG. 16A. In the example illustrated in FIG. 16A, the display apparatus according to the present embodiment performs a process corresponding to the “determination operation” when the display of the focus frame becomes a state indicated by D of FIG. 16A (that is, when a set time passes after the start of the feedback).

The method of feeding the operation corresponding to the acquired operation signal back to the user is not limited to the method of changing the display of the focus frame, as in FIG. 16A. For example, as illustrated in FIG. 16B, the display apparatus according to the present embodiment can feed an operation corresponding to an acquired operation signal back to the user by expressing progress. In the example indicated by B of FIG. 16, the display apparatus according to the present embodiment performs a process corresponding to an operation indicated by an acquired operation signal when the expression of the progress becomes a state indicated by H off FIG. 16B (that is when a set time passes after the start of the feedback).

In FIGS. 16A and 16B, the examples in which the display apparatus according to the present embodiment visually feeds the operation corresponding to the acquired operation signal back to the user have been described. However, the method of feeding the operation corresponding to the acquired operation signal back to the user is not limited to the method of giving the visual feedback. For example, the display apparatus according to the present embodiment can also give audible feedback using audio (including music) corresponding to a kind of operation. Further, the display apparatus according to the present embodiment may give feedback of the operation corresponding to the acquired operation signal to the user, for example, by giving feedback of other senses of the user such as a sense of touch or a sense of smell.

As described above, for example, by giving the feedback of the operation corresponding to the acquired operation signal to the user, the user can recognize that an action unintended as an operation is detected by the operation device. Further, the display apparatus according to the present embodiment performs a process based on the acquired operation signal after the feedback starts and then the set time passes. Therefore, the probability of the process unintended by the user being performed in the display apparatus according to the present embodiment is reduced.

Accordingly, by performing the foregoing process, the display apparatus according to the present embodiment can improve the operability of the user.

A method of preventing the operability of the user from deteriorating due to an action unintended as an operation according to the present embodiment being detected by the operation device is not limited to the foregoing method.

For example, in the display system 1000 according to the present embodiment, a user's action (for example, a tapping action or a double-tapping action) for which a detection time at which an operation is detected on the operation device is short may not be set as an operation recognized in the display apparatus according to the present embodiment.

In the display system 1000 according to the present embodiment, for example, an operation recognized in the display apparatus according to the present embodiment may be changed based on a detection time and a detection position at which an operation is detected in the operation device. As an example in which an operation recognized in the display apparatus according to the present embodiment is changed based on the detection time and the detection position, an example in which a “determination” command is allocated at the time of detection of a finger or the like for a time equal to or greater than a time set in the first sensor 22 indicated by C of FIG. 1 and a “cancellation” command is allocated at the time of detection of a finger or the like for a time equal to or greater than a time set in the second sensor 24 indicated by C of FIG. 1 can be exemplified.

### (ii) SECOND EXAMPLE

### Animation Display

For example, as described with reference to FIGS. 14 and 15A to 15H, the display apparatus according to the present embodiment transitions the display content displayed on the display surface based on the operation signal in response to the user's operation illustrated in FIGS. 13A to 13E or the detected trigger. When the display content displayed on the display surface is transitioned, the display apparatus according to the present embodiment can use animation display.

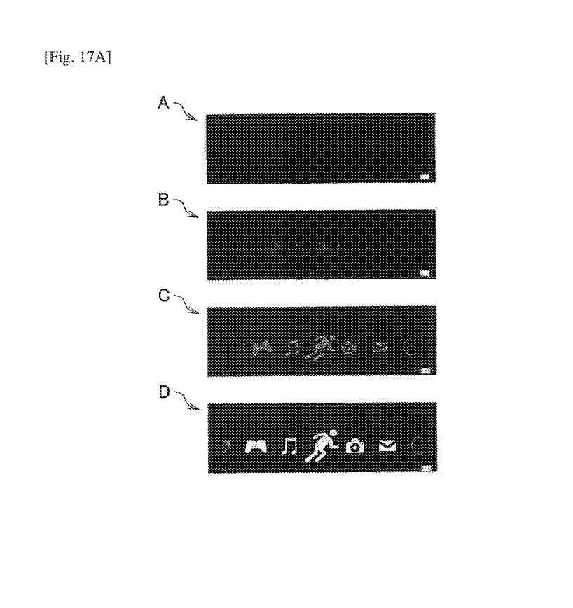

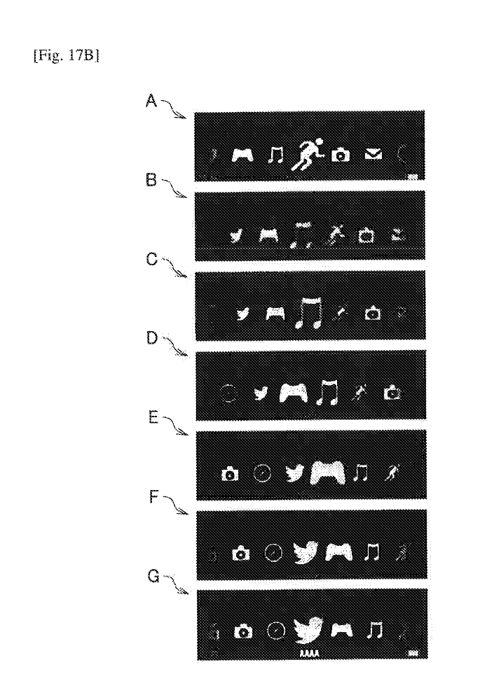

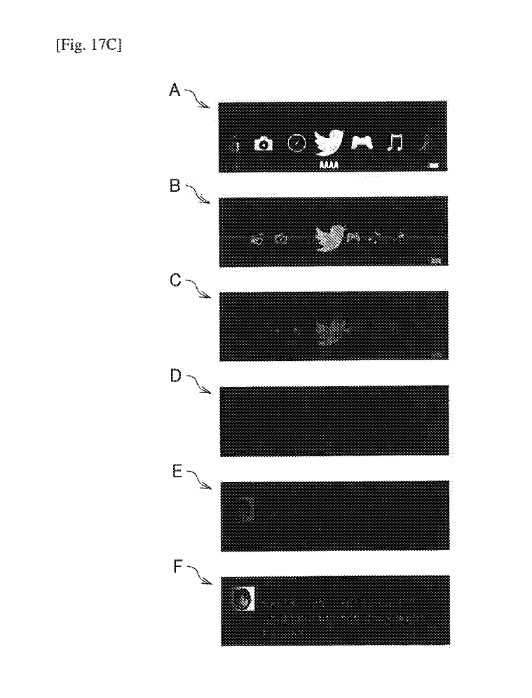

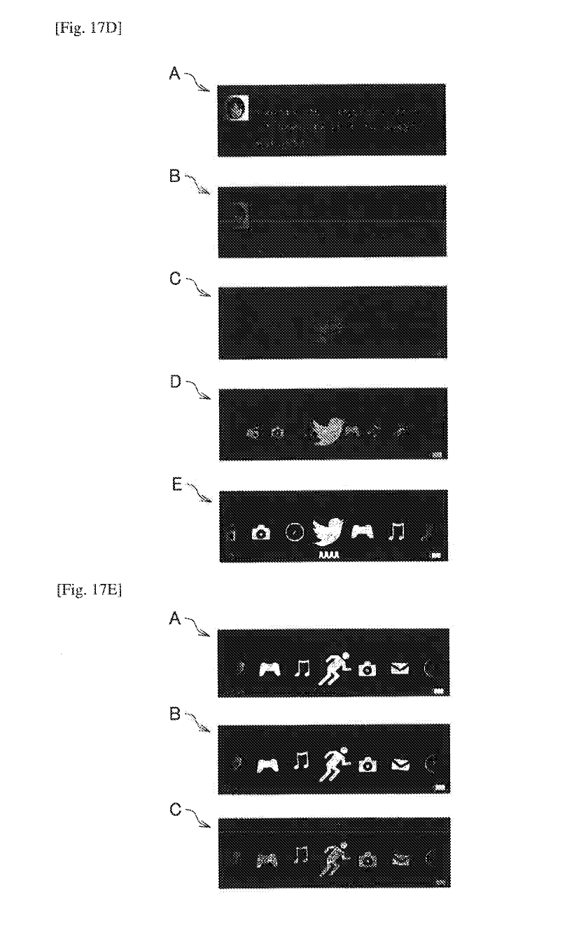

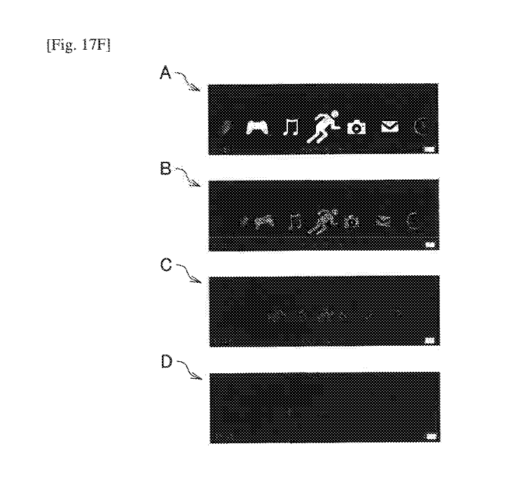

FIGS. 17A to 17F are explanatory diagrams illustrating other examples of the display in the display system 1000 according to the present embodiment and illustrate examples of animation display.

FIG. 17A illustrates an example of the animation display when the display on the display surface of the display apparatus according to the present embodiment is changed from an off-state to an on-state. Here, A to D illustrated in FIG. 17A indicate a change in the display content displayed on the display surface chronologically in the order of A to D.

When the display on the display surface of the display apparatus according to the present embodiment is in the off-state and the user performs “the operation of turning on/off the display on the display surface” illustrated in FIG. 13E, the display apparatus according to the present embodiment turns on the display on the display surface based on an operation signal in response to this operation. Then, the display apparatus according to the present embodiment display's the display objects on the display surface, for example, by the animation display indicated by A to D of FIG. 17A.

When the display on the display surface of the display apparatus according to the present embodiment is changed from the off-state to the on-state and, for example, when the animation display indicated by A to D of FIG. 17A is performed, a field of view of the user is not abruptly blocked due to the fact that the display objects to be displayed do not appear on the display surface. Further, since the display objects to be displayed do not abruptly appear on the display surface, attention of the user is prevented from being disrupted by the abruptly appearing display objects.

Accordingly, when the display on the display surface of the display apparatus according to the present embodiment is changed from the off-state to the on-state, convenience or operability of the user can be prevented from deteriorating, for example, by performing the animation display indicated by A to D of FIG. 17A.

FIG. 17B illustrates an example of the animation display, for example, when the user performs the operation illustrated in FIG. 13B or 13C to select a display object on the reference screen indicated by B1 or B2 of FIG. 14. Here, A to G illustrated in FIG. 17B indicate a change in the display content displayed on the display surface chronologically in the order of A to G.

For example, as indicated by A to G of FIG. 17B, the display apparatus according to the present embodiment displays the display objects on the display surface, for example, using animation display in which the sizes of the display objects or transparency of the display objects are changed.

FIG. 17C illustrates an example of the animation display, for example, when the user performs the “determination operation” illustrated in FIG. 13A to select a display object on the reference screen indicated by B1 or B2 of FIG. 14. Here, A to F illustrated in FIG. 17C indicate a change in the display content displayed on the display surface chronologically in the order of A to F.

For example, as indicated by A to D of FIG. 17C, the display apparatus according to the present embodiment uses the animation display in which a display object indicated by the operation signal in response to the “determination operation” is continued displayed on the display surface longer than the other display objects. For example, as indicated by E and F of FIG. 17C, the display apparatus according to the present embodiment displays the display content corresponding to the display object indicated by the operation signal corresponding to the “determination operation” on the display surface using the animation display. For example, as indicated by F of FIG. 17C, in the case of a screen in which a sentence is displayed, the display apparatus according to the present embodiment may present the entire sentence to the user, for example, by the automatic scroll display, as described above.

FIG. 17D illustrates an example of the animation display when the user performs “the return operation or the cancellation operation” illustrated in FIG. 13A at the time of the display of the display content indicated by F of FIG. 17C on the display surface. Here, A to E illustrated in FIG. 17D indicate a change in the display content displayed on the display surface chronologically in the order of A to E.

For example, when the user performs “the return operation or the cancellation operation” illustrated in FIG. 13A at the time of the display of the display content indicated by F of FIG. 17C on the display surface, the display apparatus according to the present embodiment transitions the display content, using animation display reverse to the animation display illustrated in FIG. 17C (that is, animation display in which the chronological order corresponds to the order of F to A of FIG. 17C), as indicated by A to E of FIG. 17D.

FIG. 17E illustrates an example of the animation display when the display on the display surface of the display apparatus according to the present embodiment is in the on-state and no operation signal is acquired even after elapse of a set predetermined period. The animation display illustrated in FIG. 17E corresponds to animation display in a so-called standby state. Here, A to C illustrated in FIG. 17E indicate a change in the display content displayed on the display surface chronologically in the order of A to C.

When the display on the display surface of the display apparatus according to the present embodiment is in the on-state and no operation signal is acquired even after the elapse of the set predetermined period, the display apparatus according to the present embodiment changes a display position of each display object for each display object, for example, as indicated by A to C of FIG. 17C. For example, as indicated by A to C of FIG. 17C, the change of the display position of each display object for each display object enables the user to feel the sense of floating of each respective display object.

FIG. 17F illustrates an example of the animation display when the display on the display surface of the display apparatus according to the present embodiment is changed from the on-state to the off-state. Here, A to D illustrated in FIG. 17F indicate a change in the display content displayed on the display surface chronologically in the order of A to D.

When the display on the display surface of the display apparatus according to the present embodiment is changed from the on-state to the off-state, the display apparatus according to the present embodiment transitions the display content, using animation display reverse to the animation display illustrated in FIG. 17A (that is, animation display in which the chronological order corresponds to the order of D to A of FIG. 17A), for example, as indicated by A to D of FIG. 17F.

When the display content displayed on the display surface is transitioned, the display apparatus according to the present embodiment can use, for example, the animation display illustrated in FIGS. I 7A to I 7F. Of course, the animation display according to the present embodiment is not limited to the examples illustrated in FIGS. 17A to 17F.

The preferred embodiments of the present disclosure have been described in detail with reference to the appended drawings, but the technical scope of the present disclosure is not limited to the embodiments. It should be understood by those skilled in the art that various modifications and alterations may occur depending on design requirements and other factors insofar as they are within the technical scope of the appended claims or the equivalents thereof, and the modifications and the alterations are construed to pertain to the technical scope of the present disclosure.

For example, the case in which the program (computer program) causing a computer to function as the display control device according to the present embodiment is provided has been described, but the embodiment can also provide a recording medium storing the program.

For example, in the display system according to the present embodiment, such as the display system 1000 illustrated in FIG. 11, for example, a plurality of apparatuses included in the display system according to the present embodiment may serve as the display control device according to the present embodiment. For example, the display system according to the present embodiment may further include the display control device according to the present embodiment.

The above-described configurations show examples of the embodiment and, of course, pertain to the technical scope of an embodiment of the present disclosure.

Additionally, the present technology may also be configured as below.

(1) A display control apparatus to control display of a movable object on a display plane such that, in response to a movement operation, a movement trajectory of the movable object has a component that appears perpendicular to the display plane, wherein the movement operation is initiated when an operation device receives a user input having a component perpendicular to the display plane.

(2) The display control apparatus as recited in (1), wherein the movable object is scrolled based on the movement operation.

(3) The display control apparatus as recited in (1) or (2), wherein a shape of the movement trajectory is changed based a location where the user input is received.

(4) The display control apparatus as recited in any of (1) to (3), wherein the component of the movement trajectory appearing perpendicular to the display plane is changed based on an acquisition state corresponding to the user input.

(5) The display control apparatus as recited in any of (1) to (4), wherein the display plane is provided in a wearable display device.

(6) The display control apparatus as recited in any of (1) to (5), wherein the wearable display device is a head mounted display and the operation device is provided on a temple part of the head mounted display.

(7) The display control apparatus as recited in any of (1) to (6), wherein a component of the movement trajectory is along the display plane.

(8) The display control apparatus as recited in any of (1) to (7), wherein the operation device is positioned at a side of the user and the component of the movement trajectory that appears perpendicular to the display plane is evident at the side of the user at which the operation device is positioned.

(9) The display control apparatus as recited in any of (1) to (8), wherein at least a part of the movement trajectory is bent or is a curved line.

(10) The display control apparatus as recited in any of (1) to (9), wherein the apparatus displays the movement trajectory of the movable object based on a type of the operation device such that whether or not a component of the movement trajectory appears perpendicular to the display plane depends upon the type of operation device.

(11) The display control apparatus as recited in any of (1) to (10), wherein the apparatus is operable to control display of a plurality of objects and to move a part of the plurality of objects along the movement trajectory in response to the movement operation.

(12) The display control apparatus as recited in any of (1) to (11), wherein the movable object is displayed in perspective.

(13) The display control apparatus as recited in any of (1) to (12), wherein the movable object is a cursor.

(14) The display control apparatus as recited in any of (1) to (13), wherein the operation device is embedded in a wearable device and comprises a sensing surface to identify the user input.

(15) The display control apparatus as recited in any of (1) to (14), wherein the operation device identifies the user input through one of a proximity sensor, a touch sensor, and an image sensor.

(16) The display control apparatus as recited in any of (1) to (15), wherein the apparatus is one of a head mounted display device, a cellular phone, a personal computer, and a monocle.

(17) A head mounted display, including a display; an operation device to receive a user input having a component perpendicular to a display plane of the display and indicating a movement operation; and a display control apparatus to control display of a movable object on the display such that, in response to the movement operation, a movement trajectory of the movable object appears to have a component perpendicular to the display plane.

(18) A display control apparatus including circuitry to control display of a movable object on a display plane such that, in response to a movement operation, a movement trajectory of the movable object appears to have a component perpendicular to the display plane, wherein the movement operation is initiated when an operation device receives a user input having a component perpendicular to the display plane.

(19) A method for controlling a display including controlling display of a movable object on a display plane of the display such that, in response to a movement operation, a movement trajectory of the movable object appears to have a component perpendicular to the display plane, wherein the movement operation is initiated when an operation device receives a user input having a component perpendicular to the display plane.

(20) A non-transitory computer-readable medium having stored thereon a computer-readable program for implementing a method for controlling a display, the method including controlling display of a movable object on a display plane of the display such that, in response to a movement operation, a movement trajectory of the movable object appears to have a component perpendicular to the display plane, wherein the movement operation is initiated when an operation device receives a user input having a component perpendicular to the display plane.

(21) A display control device including:

a display control unit that controls display of display objects displayed on a display surface in a display device mounted on a user so that a display surface on which the display objects are displayable is located in front of the user,

wherein the display control unit controls the display of the display objects such that at least a part of a trajectory along which the display objects are moved indicates a trajectory having a vertical direction component with respect to the display surface based on an operation signal acquired in response to detection in an operation device installed at a position of a side of the user in the display device.

(22) The display control device according to (21), wherein, based on an acquisition state of the operation signal, the display control unit selectively controls the display of the display objects such that at least the part of the trajectory along which the display objects are moved indicates the trajectory having the vertical direction component with respect to the display surface.

(23) The display control device according to (22), wherein, when the operation signal is acquired, the display control unit controls the display of the display objects such that at least the part of the trajectory along which the display objects are moved indicates the trajectory having the vertical direction component with respect to the display surface, and

wherein the display control unit controls the display of the display objects such that at least the part of the trajectory along which the display objects are moved indicates the trajectory having the vertical direction component with respect to the display surface, and then controls the display of the display objects such that the entire trajectory along which the display objects are moved indicates a trajectory having no vertical direction component with respect to the display surface, when the operation signal is not acquired in a set predetermined time.

(24) The display control device according to any one of (21) to (23), wherein, when the operation signal is acquired, the display control unit displays at least some of the display objects displayed on the display surface so that some of the display objects have the vertical direction component with respect to the display surface.

(25) The display control device according to (24),

wherein the display control unit displays some display objects among the display objects displayed on the display surface so that the display objects have no vertical direction component with respect to the display surface, and

wherein the display control unit displays other display objects among the display objects displayed on the display surface so that the other display objects have the vertical direction component with respect to the display surface.

(26) The display control device according to (24), wherein the display control unit displays all of the display objects displayed on the display surface so that all of the display objects have the vertical direction component with respect to the display surface.

(27) The display control device according to any one of (21) to (26), wherein, when the operation signal is not acquired, the display control unit controls the display of the display objects such that the entire trajectory along which the display objects are moved indicates a trajectory having no vertical direction component with respect to the display surface.

(28) The display control device according to (27), wherein the display control unit displays all of the display objects displayed on the display surface such that all of the display objects have no vertical direction component with respect to the display surface.

(29) The display control device according to any one of (21) to (28), wherein, when the operation signal is acquired, the display control unit moves the display object along the trajectory by scrolling the display object in a direction corresponding to an operation direction indicated by the operation signal.

(30) The display control device according to any one of (21) to (29), wherein, when the operation signal is acquired in response to a detection in an operation device other than the operation device installed at the position of the side of the user in the display device, the display control unit does not display the display objects such that at least the part of the trajectory along which the display objects are moved indicates the trajectory having the vertical direction component with respect to the display surface.

(31) The display control device according to any one of (21) to (30), wherein the operation device detects an operation input on the operation device by the user or proximity of the user to the operation device.

(32) A display device including:

a display unit that includes a display surface on which a display object is displayable, the display surface being located in front of a user when the display device is mounted on the user;

an operation unit that is installed at a position of a side of the user when the display device is mounted on the user; and

a display control unit that controls display of the display object displayed on the display surface,

wherein the display control unit controls the display of the display object such that at least a part of a trajectory along which the display object is moved indicates a trajectory having a vertical direction component with respect to the display surface based on an operation signal acquired in response to detection in the operation unit.

(33) The display device according to (32), wherein the operation unit is provided on a temple member located at a temple part of the user when the display device is mounted on the user.

(34) The display device according to (32) or (33), wherein the display device is a head-mounted display mounted on a head part of the user.

(35) A display control method including:

controlling display of a display object displayed on a display surface in a display device mounted on a user so that a display surface on which the display object is displayable is located in front of the user,

wherein, in the controlling step, the display of the display object is controlled such that at least a part of a trajectory along which the display object is moved indicates a trajectory having a vertical direction component with respect to the display surface based on an operation signal acquired in response to detection in an operation device installed at a position of a side of the user in the display device.

(36) A program for causing a computer to execute:

controlling display of a display object displayed on a display surface in a display device mounted on a user so that a display surface on which the display object is displayable is located in front of the user,

wherein, in the controlling step, the display of the display object is controlled such that at least a part of a trajectory along which the display object is moved indicates a trajectory having a vertical direction component with respect to the display surface based on an operation signal acquired in response to detection in an operation device installed at a position of a side of the user in the display device.

### REFERENCE SIGNS LIST

10 display unit
12 operation unit
14 temple member
16 bridge member
18 modern member
20 pad member
22 first sensor
24 second sensor
100 display control device
102 communication unit
104 control unit
110 display control unit
1000 display system

1. A display control apparatus
to control display of a movable object on a display plane such that, in response to a movement operation, a movement trajectory of the movable object has a component that appears perpendicular to the display plane, wherein the movement operation is initiated when an operation device receives a user input having a component perpendicular to the display plane.

2. The display control apparatus as recited in claim 1, wherein the movable object is scrolled based on the movement operation.

3. The display control apparatus as recited in claim I, wherein a shape of the movement trajectory is changed based a location where the user input is received.

4. The display control apparatus as recited in claim 1, wherein the component of the movement trajectory appearing perpendicular to the display plane is changed based on an acquisition state corresponding to the user input.

5. The display control apparatus as recited in claim 1, wherein the display plane is provided in a wearable display device.

6. The display control apparatus as recited in claim 5, wherein the wearable display device is a head mounted display and the operation device is provided on a temple part of the head mounted display.

7. The display control apparatus as recited in claim 1, wherein a component of the movement trajectory is along the display plane.

8. The display control apparatus as recited in claim 1, wherein the operation device is positioned at a side of the user and the component of the movement trajectory that appears perpendicular to the display plane is evident at the side o he user at which the operation device is positioned.

9. The display control apparatus as recited in claim 1, wherein at least a part of the movement trajectory is bent or is a curved line.

10. The display control apparatus as recited in claim 1, wherein the apparatus displays the movement trajectory of the movable object based on a type of the operation device such that whether or not a component of the movement trajectory appears perpendicular to the display plane depends upon the type of operation device.

11. The display control apparatus as recited in claim 1, wherein the apparatus is operable to control display of a plurality of objects and to move a part of the plurality of objects along the movement trajectory in response to the movement operation.

12. The display control apparatus as recited in claim 1, wherein the movable object is displayed in perspective.

13. The display control apparatus as recited in claim 1, wherein the movable object is a cursor.

14. The display control apparatus as recited in claim 1, wherein the operation device is embedded in a wearable device and comprises a sensing surface to identify the user input.

15. The display control apparatus as recited in claim 1, wherein the operation device identifies the user input through one of a proximity sensor, a touch sensor, and an image sensor.

16. The display control apparatus as recited in claim 1, wherein the apparatus is one of a head mounted display device, a cellular phone, a personal computer, and a monocle.

17. A head mounted display, comprising:
a display;
an operation device to receive a user input having a component perpendicular to a display plane of the display and indicating a movement operation; and
a display control apparatus to control display of a movable object on the display such that, in response to the movement operation, a movement trajectory of the movable object appears to have a component perpendicular to the display plane.

18. A display control apparatus comprising circuitry to control display of a movable object on a display plane such that, in response to a movement operation, a movement trajectory of the movable object appears to have a component perpendicular to the display plane, wherein the movement operation is initiated when an operation device receives a user input having a component perpendicular to the display plane.

19. A method for controlling a display comprising controlling display of a movable object on a display plane of the display such that, in response to a movement operation, a movement trajectory of the movable object appears to have a component perpendicular to the display plane, wherein the movement operation is initiated when an operation device receives a user input having a component perpendicular to the display plane.

20. A non-transitory computer-readable medium having stored thereon a computer-readable program for implementing a method for controlling a display, the method comprising controlling display of a movable object on a display plane of the display such that, in response to a movement operation, a movement trajectory of the movable object appears to have a component perpendicular to the display plane, wherein the movement operation is initiated when an operation device receives a user input having a component perpendicular to the display plane.
